(19) United States
(12) Patent Application Publication
(10) Pub. No.: US 2002/0097715 A1
(43) Pub. Date: Jul. 25, 2002

(54) Message format for communicating financial information

(76) Inventor: Michael L. Roerick, Carrollton, TX (US)

Correspondence Address: Roger N. Chauza, HOWISON, CHAUZA, THOMA,, HANDLEY & ARNOTT, L.L.P., P.O. Box 741715, Dallas, TX, 75374-1715, US

(21) Appl. No.: 09/920,546

(22) Filed: Aug. 1, 2001

Related U.S. Application Data
(60) Provisional application No. 60/221,042, filed on Jul. 27, 2000.

(51) Int. Cl. H04J 3/24

(52) U.S. Cl. 370/389; 370/474

(57) ABSTRACT

A transmission message having a fixed terminal information segment with a field defining the format of a variable field authorization segment, and with a field defining the format of a variable field service payload segment. The fixed terminal information segment has other fields defining parameters of a terminal from which the transmission message is transmitted. The authorization segment has fields defining a method of payment by a user of the terminal. The service payload segment has fields defining the goods or services desired to be purchased by the user.

### BACKGROUND OF THE INVENTION

Early expressions of electronic commerce include the practice of “wiring” money from one individual to another over a telegraph system. Wiring of funds continues into the present time and generally consists of a deposit of cash, a certified check, or a similar instrument of a specific monetary amount plus a service fee, with an agent who then communicates an order to a distant agent to pay out the specific amount to an individual, a company, or a bank. Accounts are then settled conventionally, as by transfer of currency, clearance of checks, or the like. Electronic commerce may be generally defined as the exchange of monetary amounts for goods, services, or the like, without the direct use of currency, implemented by non-vocal electronic communications.

More recently, the use of credit cards and debit cards to make purchases often involves the electronic transfer of funds, including electronic messages of a request and then an authorization to debit a given amount from one account and credit that amount to another account. For example, purchasing a product over the Internet may involve the electronic submission of a credit card number, an electronic communication to the credit card issuer for authorization of a total purchase price, and an electronic debiting of the customer's account when the purchase process is completed. The use of such a card to obtain cash from an ATM (automatic teller machine) also involves the equivalent of an electronic transfer of funds, including the communication of an account number, a PIN personal identification number), and a monetary amount to a bank, and a response of an authorization to dispense the requested amount of cash from the ATM. Electronic commerce benefits consumers and businesses in terms of convenience, security, and accounting.

The majority of present day electronic commerce activities require consumers to have at least an established bank account and usually one or more credit card accounts. There are many persons, not only in the United States but throughout the world, who could benefit from electronic (i.e., “unbanked”) commerce but who do not have established bank or credit card accounts. While electronic transactions constitute a considerable percentage of current commercial transactions, the benefits of electronic commerce could be expanded to a much greater degree by new methods, infrastructure, and equipment.

The millions of “unbanked” people generally carry out financial transactions by the use of cash, money order, stored value card, or a similar vehicle that does not require a bank to complete the transaction. The use of cash to purchase goods and services is much more cumbersome to the person, as many of the transactions require some interface with a person, whether it be for the purchase of a money order, or the actual payment to an attendant, clerk representative, etc.

As yet another area in which cash or other similar monetary medium is required is the gaming field when gambling is involved. Here, many regulations and policies do not allow a person to use a credit card to purchase lottery tickets, to obtain an advance for gambling, etc. In these instances, resort must be made to cash or a similar monetary medium.

Many people are accustomed to the use of personal or business checks to pay for goods and services. The use of checks is a well established procedure for transferring value without using currency. However, the disadvantage of using a check is that the goods and services may be obtained on the writing of a check, but the account associated with the check may indeed not have sufficient finds (NSF) for transfer by the bank to the payee (the merchant) of the check. In an attempt to guard against this, merchants make a practice of obtaining information from the payor (the customer), such as driver's license number, telephone number, and any other pertinent information that may not be printed on the check itself. Despite all of these precautionary measures, merchants encounter numerous checks that are returned due to insufficient funds. Presently, the only measures that produce some modicum of results is to write or otherwise communicate with the payor of the NSF check in an attempt to convince them to make good on the check; refer the matter to a collection agency; or file a complaint with the judicial system in an attempt to enforce collection of the funds.

When dealing with monetary funds, it is highly important to maintain a certain degree of secrecy with respect to personal information, such as account information, personal identification number (PIN), credit card number, etc. The secrecy of such information becomes especially important when a person must enter such information into a terminal, device or machine. When such personal information is entered into a machine, electronic signals carrying the information are transmitted to remote locations. The privacy of such information must be guarded in order to prevent unauthorized retrieval of such information and subsequent illegal use thereof. It has been a practice with ATM machines to encode or otherwise encrypt the PIN number entered by way of a separate numeric keypad. The encryption of the PIN provides a high degree of safety against the unauthorized retrieval and decrypting of the signals. However, the use of a numeric keypad limits the type of information and the convenience of the customer in entering the information. In typical terminal and human interfaces, the manner in which information is communicated therebetween constitutes a display for providing the customer with instructions or directions, and a keypad or other buttons for use by the customer to enter the choices. As noted above, while this communication mechanism does allow the customer to communicate with the financial terminal, it is often inconvenient, confusing and slow.

From the foregoing, it can be seen that a need exists for a funds transaction system where cash can be easily deposited, and through the use of electronic funds transfer, either cash can be dispensed at another location, or goods and services can be purchased. Yet another need exists for a funds transaction system that allows cash to be deposited if for example, a kiosk at one location, and be dispensed at another location in a foreign currency. Yet another need exists for a monetary reconciliation system which records the unbanked transactions and verified proper payment to vendors, as well as the owners/operators of the equipment and systems used for completing the unbanked transactions. An additional need exists for an efficient and expandable transmission format utilized for communicating financial information between systems of the network. A further need exists for a financial system that allows a person to redeem an NSF check in a private environment, by communication via a financial system so that funds can be applied by the payor to the payee's account. Another need exists for a method of encrypting private information entered via a touch screen for a financial terminal to provide a high degree of security.

### SUMMARY OF THE INVENTION

The present invention is directed to an electronic commerce transaction system including an Electronic Transaction Server (ETS), which is a gateway that links the processing of payments with the purchase of a product or service. The ETS is a common gateway between electronic kiosks, a purchase approval system or systems, and vendors. The ETS communicates to automated kiosks or other host systems (which may interface to customers via a kiosk, personal computer, or any other device available to the end-user). The financial portion of the transaction is approved using all major forms of payment (credit, debit, cash, or cash equivalent). The ETS provides a complete solution to retailers or vendors who wish to sell goods or services electronically.

The ETS is responsible for approving the financial portion of the transaction; completing the purchase of the chosen good or service; responding to the client device to acknowledge the purchase; and dispensing media for the end user. The back-office settlement and reporting applications insure funds are properly transferred from the customer to the vendor.

The ETS system processes transactions for enhanced services, which are goods and services beyond the typical Automated Teller Machine (ATM) functions, in addition to conventional ATM type services. The enhanced services may include such items as:

Prepaid services (Calling Cards, Smart Cards)

Negotiable Instruments (Money Orders, Bank Checks, etc.)

Tickets, Gift Certificates, Coupons

Utility payments

Cash transfers to other kiosks

Internet based goods and services provided by electronic retailers

The ETS system provides true electronic commerce via the Internet using a web-based interface at the financial kiosk or host system. In accordance with an important aspect of the invention, the electronic communications between the kiosk terminals and the ETS is by way of a format that is efficient and easily expandable to accommodate additional vendors or merchants who can be accessed through the financial network. The transmission format of the preferred form is a three-segment string, including a fixed segment that has fields that establish the format of the other two segments. The fixed segment identifies parameters of the kiosk terminal, and a field that specifies the format of the method of payment segment, and yet another field that specifies the format of the service payload segment. Hence, as new methods of payments and/or vendors arise, the format of the transmission format need not change significantly. Rather, the fixed segment of the transmission format need only specify the format of the new method of payment or the information required by the new vendor. The versatility of the communications between the systems of the financial network is thus materially enhanced.

In accordance with another aspect of the invention, the financial system is configured to allow communication between a financial terminal or device, and with a merchant's negative file data base in order to permit a customer to submit funds via the terminal and redeem an NSF check. The financial system communicates NSF check information to the terminal in response to an inquiry by the customer. The customer is advised of the amount to remit for redeeming the NSF check, and options as to the methods of payment allowed. The financial system is interactive with the customer for allowing private redemption of the NSF check.

A multi-functional financial center is provided for customers to initiate and carry out banked and unbanked financial transactions. In a preferred form of the invention, bidrectional communication between the terminal and the customer is by way of a touch screen. The terminal can display options on the touch screen for use by the customer in making various choices. The customer can make the choice(s) directly on the touch screen by pressing on an area fo the screen overlying the displayed choice. Importantly, all the information input by the customer is encrypted before transmission to the processor in the terminal, and subsequently out to the financial network. In this manner, a high degree of security is provided as to all the information input into the financial system by the customer.

### OBJECTS AND ADVANTAGES OF THE INVENTION

The principal objects of the present invention are to provide an improved system for conducting commercial transactions; to provide such a system which increases the convenience, speed, security, and accounting efficiency of certain kinds of commercial transactions by implementing the transaction electronically; to provide such a system which makes electronic commerce capabilities available to persons without bank accounts, as well as to those with accounts; to provide an electronic commerce transaction server which combines many of the capabilities of conventional ATM machines with additional electronic commerce capabilities which can be accessed using cash, credit cards, debit cards, smart cards, or the like; to provide such a system with the capability of being accessed securely by individuals over the Internet or by ways of kiosks at publicly accessible locations; and to provide such an electronic commerce transaction system which is economical to implement, which is convenient and efficient in operation, and which is particularly well adapted for its intended purposes.

### BRIEF DESCRIPTION OF THE DRAWINGS

Further features and advantages will become apparent from the following and more particular description of the preferred and other embodiments of the invention, as illustrated in the accompanying drawings in which like reference characters generally refer to the same parts, elements or functions throughout the views, and in which:

FIG. 1 is a block drawing illustrating the principal components of the electronic commerce transaction network which embodies the present invention;

FIG. 2 is a block diagram illustrating the principal components of an electronic commerce kiosk employed in the transaction system of the present invention;

FIG. 3 is a block diagram illustrating the principal components of an electronic commerce kiosk which is referred to as a multifunction financial center;

FIG. 4 is a detailed block diagram of the financial network configured according to a preferred form of the invention;

FIG. 5 is flowchart showing the various functions carried out by the financial network of FIG. 4, for carrying out banked and unbanked transactions using an unattended multi-functional center or terminal;

FIG. 6 is a flowchart of the various functions carried out by the financial network of FIG. 4, for carrying out banked and unbanked transactions using an attended multi-functional center or terminal;

FIG. 7a is a diagram of a transmission message format utilized in communicating between various systems of a financial network;

FIG. 7b is a more detailed transmission message format of FIG. 7a, showing the various fields that can be utilized;

FIG. 7c is a diagram of a transmission message format used by the transaction server;

FIG. 8 is a block diagram of a financial system configured to allow customers to redeem NSF checks;

FIG. 9 is a flowchart illustrating the functions carried out by the financial system of FIG. 8 in redeeming an NSF check;

FIG. 10 is another flow chart of the operations of the financial system of FIG. 8 in responding to a status inquiry by a payor; and

FIG. 11 is a sample printout report supplied from the negative file database of the retailer in response to a payor inquiry.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefor, specific structural and functional details disclosed herein are not to be interpreted as limiting, but merely as a basis for the claims and as a representative basis for teaching one skilled in the art to variously employ the present invention in virtually any appropriately detailed structure. Financial transaction network

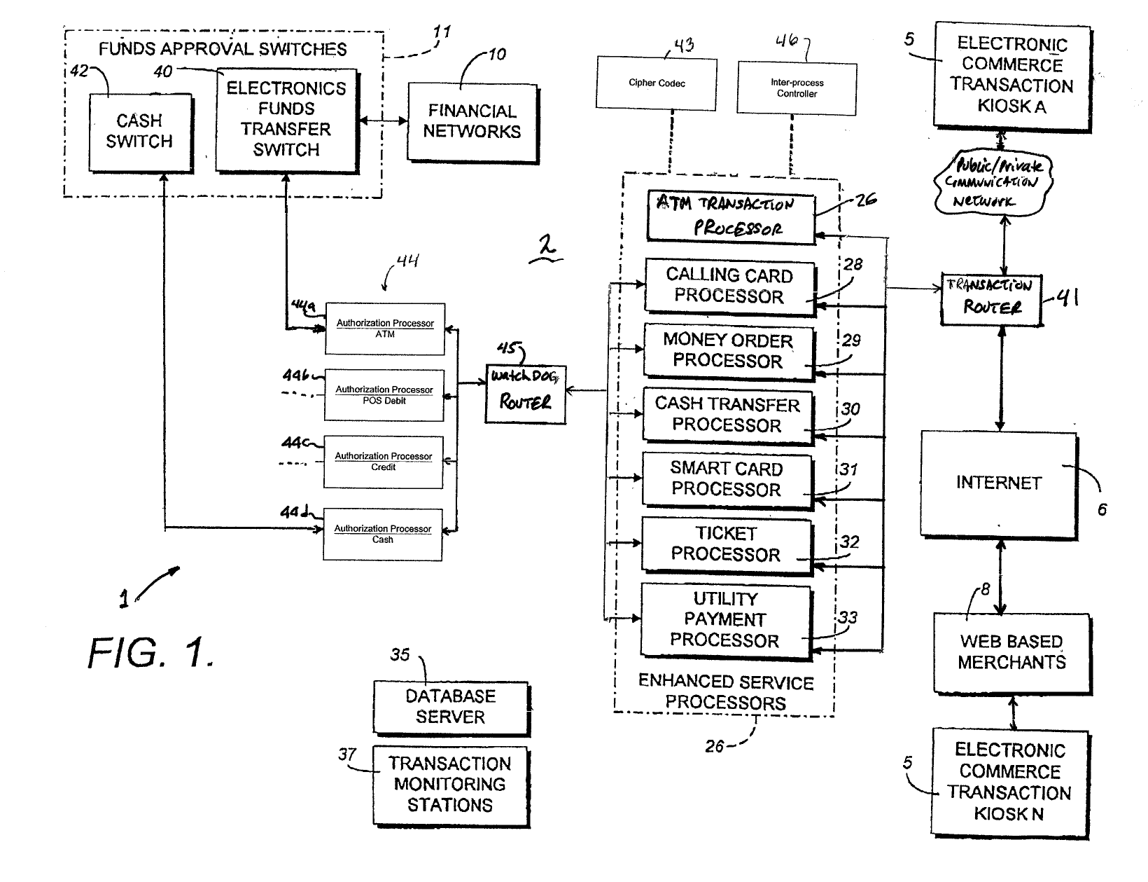

Referring to FIG. 1 of the drawings, the reference number 1 generally designates an electronic commerce transaction network which embodies the principles and concepts of the present invention. The network 1 includes an electronic commerce transaction server 2 to which are interfaced a number of components through which the network 1 operates. The electronic transaction server, or ETS 2, is coupled to a number of electronic commerce transaction “kiosks” 5, as through dedicated communication lines or dial-up lines or over the internet 6. The interface to the internet 6 also provides access to web-based merchants 8 through the server 2, whereby customers using the network 1 can make purchases by way of the kiosks 5. The server 2 is also interfaced to financial networks 10 through finds approval “switches” 11 to enable banking, conventional ATM type transactions, or cash transactions through the kiosks 5. The transaction server 2 may be a single computer or a network of computers executing components of the electronic commerce transaction server software.

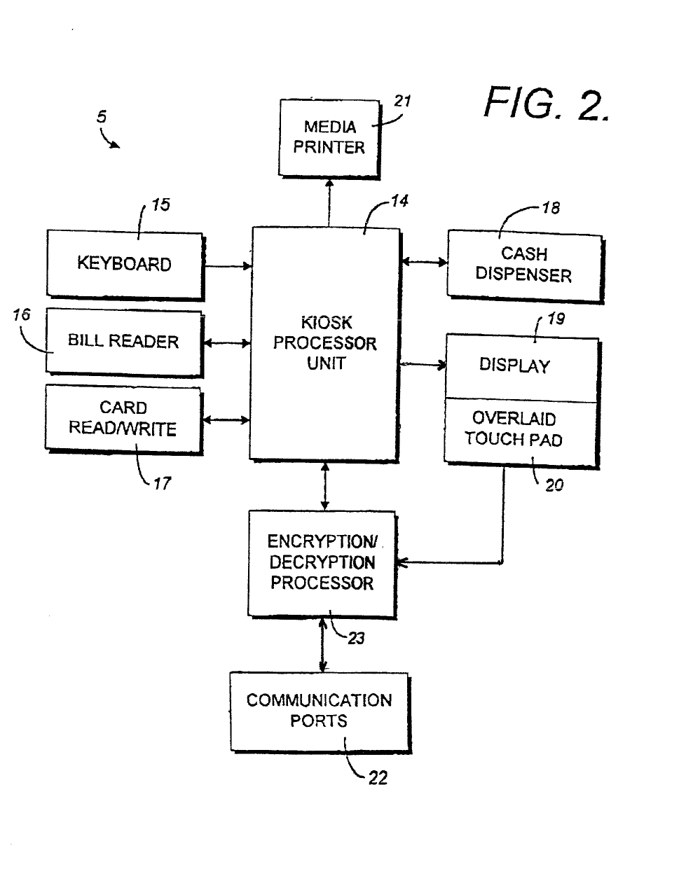

Referring to FIG. 2, an exemplary kiosk 5 includes a kiosk central processing unit or processor unit 14 to which are interfaced a keyboard 15, a currency or bill reader 16, a card read/write device 17, a cash dispenser 18, a video display 19 which may be overlaid by a membrane tactile input array or “touch pad” or touch screen 20, and a media printer 21. The kiosk 5 includes communication ports 22 which preferably operate through an encryption/decryption processor 23. The encryption/decryption processor 23 may be implemented either as software, firmware, or a combination of software and firmware. The communication ports 22 may interface to a dedicated communication line, a dial-up line, or the internet 6.

The card read/write device 17 provides for reading credit cards and debit cards and for reading form and writing to “smart” cards, which have the capability of having monetary values credited thereto or debited therefrom. The bill reader 16 allows the kiosk 5 to receive and read currency notes or cash for transactions conducted thereon. The media printer 21 provides for printing instruments such as money orders, tickets for various purposes, coupons, and the like, as well as transaction receipts. The touch pad 20 allows graphical user interface functions in relation to displayed graphics or indicia, in the manner of a mouse. Touch inputs to the touch screen 20 are converted to signals which a processor 14 in the kiosk interpret in much the same manner as mouse clicks.

The kiosks 5 may be a self-supporting structure positioned in a publically accessible area, such as a shopping mall, business complex, or the like. Alternatively, the kiosks 5 may be incorporated into a single wall, in the manner of many ATM's. Likewise, the kiosks 5 are preferably provided with high levels of security, such as by electronic surveillance and alarms, security guards, and the like.

The server 2 of FIG. 1 includes a number of so-called “enhanced service” processors 26 which provide services that extend beyond the types of services offered by conventional automatic teller machines. Such exemplary processors may include, but are not limited specifically to, an ATM transaction processor 26, a telephone calling card processor 28, a money order processor 29, a cash transfer processor 30, a smart card processor 31, a ticket processor 32, a utility payment processor 33, and the like.

General Design

The ETS 2 includes a transaction router 41. Transaction routers 41 interface the ETS 2 with the data delivery network. Multiple transaction routers 41 may be running simultaneously to handle different types of connections to the data delivery networks. Connection types can be TCP/IP to X.25, BySnc, SNA/SDLC, or other types.

The transaction router 41 is designed to carry out a simple analysis of the incoming message and route the transaction message to the appropriate enhanced service processor 26. In addition, all responses delivered to the terminal from the ESP 26 are routed back through the transaction router 41.

The ETS 2 selects and operates an enhanced service processor 26 for each enhanced service to be sold at the financial terminal. This module is also responsible for accessing the inter-process controller 46 to assign a Trace ID to the transaction. The Trace ID enables the message to be tracked throughout the life of the transaction. ESP's 26 are also responsible for decrypting the message by accessing the cipher codec 43, sending transactions to the authorization processors 44 for financial approval, and interfacing with the vendor system to purchase the goods or service. The ESP 26 may process the transaction by updating a local database 35 or may have an on-line connection to the vendor system if real-time approvals are required. Multiple ESP's 26 can operate simultaneously for improved performance and load balancing. The ESP 26 is also responsible for responding to the terminal device through the transaction router 41.

The watchdog router 45 is utilized to pass messages between modules, primarily between the ESP's 26 and authorization processors 44. The primary purpose of the watchdog router 45 is to deliver messages to modules and report back to the issuing module if a response has not been received within a specified period of time.

The watchdog router 45 is called with three basic parameters: the Requesting Module ID, the Forward-To Module ID, and a Response Timeout Value. The watchdog router 45 delivers the message to the Forward-To Module and waits for a response. If no response is delivered within the Timeout Value period of time, a timeout message is returned to the Requesting Module. The feature enables many modules to interact while operating independently of each other. In the preferred embodiment, the watchdog router 45 is not used to deliver messages between the transaction router 41 and the ESP 26.

The authorization processor 44 communicates with the financial networks to approve debit, ATM, credit an d cash transactions. An authorization processor 44 is operational for each form of payment, and may connect to multiple networks. An authorization processor 44 is programmed to carry out authorization functions that are related to ATM transactions. An authorization processor 44b is programmed to carry out authorization functions related to Point of Service (POS) debit transactions. An authorization processor 44c is programmed to carry out authorization functions related to credit transactions. Lastly, an authorization processor 44d is programmed to carry out authorization functions related to cash or money order transactions. Other types of authorization processors can be utilized to carry out transactions other than these noted above. The authorization processors 44 receive transaction messages from the watchdog router 45, reformat the message required by the financial network or cash switch 42 is inserted into the internal ETS message and is routed back to the issuing ESP 26 through the watchdog router 45.

The inter-process controller (IPC) 46 handles all system functions that require standardization between the modules in the ETS application. All routers and processors can access the IPC 46 for process identification. The IPC 46 monitors all modules operating in the system 2 and provide important statistics for load balancing and processor usage.

The IPC 46 is called by the ESP 26 to determine the Trace ID, which is employed to track the transactions throughout the system 2. This standardization becomes crucial when multiple versions of routers or processors are functioning simultaneously.

The cipher codec 43 is accessed to encrypt or decrypt all messages between the ETS 2 and terminal device. Terminal devices deliver data with an encryption method specified in the transaction, and the ESP 26 accesses the cipher codec 43 to decrypt the incoming message. Messages can also be encrypted before a response is returned. Higher security is achieved by allowing the terminal device to vary the encryption method for each transaction.

The ETS 2 is coupled to a transaction router 41. The transaction router 41 receives a transaction, determines the transaction type, and directs the transaction to the appropriate Enhanced Service Processor 26. The ESP 26 sends the message to the cipher codec 43 for decryption. The ESP 26 formats the message for the particular purchase method and sends the message to an authorization processor 44 via a watchdog router 45. The watchdog router 45 is designed to move messages through the system and report back to the issuing module if a response is not received within a specified amount of time. The authorization processor 44 formats the message and forwards the message to the appropriate financial network 10. The response from the financial network 10 will be placed into the message and routed back to the ESP 26 via the watchdog router 45. The ESP 26 then sends the purchase request to the vendor system and waits for approval. Once the item is purchased, the ESP 26 formats the proper response and sends it to the kiosk 5 via the transaction router 41. The kiosk 5 dispenses or prints the necessary media and provides a completion message to the ETS 2. The ETS 2 then stores a record of the transaction once the completion message is received.

The following sequence illustrates the flow of a transaction through the various components of the ETS 2. It is assumed that an encrypted transaction message was transmitted by a user from a terminal device, such as a kiosk 5.

Transaction Router

1. The transaction router 41 retrieves the transaction message from an incoming queue.

2. The transaction router 41 analyzes the message type and routes the transaction message to the appropriate ESP 26.

3. The transaction router 41 sends the transaction message to a queue of ESP 26 defined by the IPC 46.

Enhanced Service Processor

1. The ESP 26 retrieves the message from its incoming queue.

2. The ESP 26 calls the IPC 46 to establish a Trace ID.

3. The ESP 26 formats a payload and the ETS information into an internal message format.

4. The ESP 26 sends the transaction message to the cipher codec 43 to decrypt the transaction data.

5. The ESP 26 formats an authorization portion of the transaction massage.

6. The ESP 26 calls the watchdog router 45 with the appropriate authorization processor 44, with a Timeout Value.

Watchdog Router

1. The watchdog router 45 retrieves the internal message from an incoming queue.

2. The watchdog router 45 routes the transaction to the proper authorization processor 44.

3. The watchdog router 45 times stamps the transaction with the Timeout Value and Trace ID.

Authorization Processor (AP)

1. The AP 26 retrieves the message from an incoming queue.

2. The AP 26 reformats the message to the specification and format required of the authorizing financial network 10 or cash switch 42.

3. The AP 26 sends transaction message to the financial network 10 or cash switch 42.

4. The AP 26 receives response from financial network 10 or cash switch 42.

5. The AP 26 formats the response from the financial network (or cash switch) to the authorization information portion of the ETS internal message format.

6. The AP 26 calls the watchdog router 45 with the response message.

Watchdog Router

1. The watchdog router 45 verifies the timestamp information originally submitted by the ESP 26.

2. The watchdog router 45 sends the message to the ESP response queue.

Enhanced Service Processor

1. The ESP 26 retrieves message from the response queue.

2. The ESP 26 verifies the authorization response.

3. If a purchase is authorized, the ESP 26 formats the message to the specifications and format of the associated vendor system.

4. The ESP 26 sends the message to the vendor to purchase the goods or services.

5. The ESP 26 receives the response from the vendor.

6. The ESP 26 formats the response for the terminal device 5.

7. The ESP 26 sends message to the cipher code 43 to encrypt the transaction data.

8. The ESP 26 sends the response to the transaction router 41 response queue.

9. The ESP 26 logs the transaction in the database 35.

Transaction Router

1. The transaction router 41 retrieves response from its response queue.

2. The transaction router 41 sends the response to the terminal device 5.

The following sequence details the processing of a transaction in which the authorization portion has timed out. The first five steps are the same as described above in the processing of a normal transaction.

Enhanced Service Processor

1. The ESP 26 retrieves the message from the response queue.

2. The message received from the watchdog router 45 indicates that the authorization processor 44 did not respond in the time allotted.

3. The ESP 26 formats a “Time-out” response message for the terminal device 5.

4. The ESP 26 sends the message to the cipher code 43 to decrypt the transaction data.

5. The ESP 26 sends the message to transaction router response queue.

6. The ESP 26 logs the transaction in database 35.

If watchdog router 45 receives the response from authorization processor 44 past the timout period, the following sequence occurs.

Watchdog Router

1. The watchdog router 45 checks an internal table and does not locate the transaction specified.

2. The watchdog router 45 formats a “Time-out” message and sends the message to the authorization processor queue.

Authorization Processor

1. The authorization processor 44 retrieves “Time-out” message from the queue.

2. The authorization processor 44 formats a reversal message based on specifications of the financial network.

3. The authorization processor 44 sends the reversal message to the financial network.

4. The authorization processor 44 logs reversal transaction in the database 35.

The following sequence of operations details the processing of a transaction in which the vendor system has either timed out, or has returned an error condition. The first five steps of this operation are the same as described above in the processing of a normal transaction.

Enhanced Service Processor

1. The ESP 26 retrieves the message from the response queue.

2. The ESP 26 verifies the authorization response.

3. If a purchase is authorized, the ESP 26 formats a message according to the specifications of the vendor system.

4. The ESP 26 sends the message to the vendor system to purchase the goods or services.

5. The ESP 26 receives an error response from the vendor system or the transaction has timed out.

6. The ESP 26 formats the reversal message for the authorization processor 44.

7. The ESP 26 sends the reversal message to authorization processor 44 via the watchdog router 45.

8. The ESP 26 formats a “Service Unavailable” error message for terminal device 5.

9. The ESP 26 sends the message to the cipher codec 43 to encrypt the transaction data of the message.

10. The ESP 26 sends the message to transaction router 41 response queue.

11. The ESP 26 logs the transaction in the database 35.

Authorization Processor

1. The authorization processor 44 retrieves the reversal message from the queue.

2. The authorization processor 44 formats ta reversal message based on specifications of the financial network.

3. The authorization processor 44 sends the reversal message to financial network.

4. The authorization processor 44 logs the reversal transaction in the database 35.

The following sequence of operations details the processing when a transaction was properly processed, but a reversal is received from the terminal device 5. The first seven steps of this operation are the same as the operations described above in the processing of a normal transaction.

Transaction Router

1. The transaction 41 router retrieves a reversal transaction from its incoming queue.

2. The transaction 41 router calls the IPC 46 for a Trace ID and ESP routing information.

3. The transaction 41 router formats a payload and ETS information into an internal message format.

4. The transaction 41 router sends the internal message to the queue of ESP 26 defined by the IPC 46.

Enhanced Service Processor

1. The ESP 26 retrieves the message from its incoming queue.

2. The ESP 26 analyzes the message and determines if a terminal exception has occurred.

3. The ESP 26 formats the reversal message for the authorization processor 44.

4. The ESP 26 sends the reversal message to the authorization processor 44 via the watchdog router 45.

5. The ESP 26 formats a reversal message for the vendor system.

6. The ESP 26 sends the reversal message to the vendor system.

7. The ESP 26 logs the reversal transaction in the database 35.

Authorization Processor

1. The authorization processor 44 retrieves the reversal message from its queue.

2. The authorization processor 44 formats a reversal message based on specifications of the financial network.

3. The authorization processor 44 sends the reversal message to financial network.

4. The authorization processor 44 logs the reversal transaction in the database 35.

The ETS 2 receives a transaction and directs the transaction to the appropriate funds approval switch 11, and if approved, switches the transaction to the proper enhanced service processor 26 for approval or purchase of an item or service. Once the enhanced service transaction is completed, the ETS 2 sends a response to the financial kiosk 5. The kiosk 5 dispenses or prints the necessary media and provides a completion message to the ETS 2. The ETS 2 stores a record of the transaction once the completion message is received.

Transaction Server

The Electronic Commerce Transaction Server 2 receives financial transactions and functions as the primary gateway to all other servers/processors in the network 1. The ETS 2 is responsible for receiving the transaction, requesting financial approval and purchasing the product or service. The ETS 2 is the main interface between the: Financial Terminal or kiosk 5, Funds Approval Switches 11, Enhanced Service Processors or ESPs 26, Database Servers 35, and System Monitors 37.

Funds Approval Switches

An electronic funds transfer or EFT “Switch” 40 is used to approve the transaction when customers indicate the method of payments is bank cards. There are electronic funds transfer service companies which currently approve such transactions for conventional ATMs and provide an interface to their current platforms. The transaction between the ETS 2 and the electronic funds transfer switch 40 is typically arranged in the ISO8583 message format, which is also the standard message format employed for financial transactions with banking networks 10.

A Cash “Switch” 42 is used to approve transactions when customers choose to pay with cash. The client device can accept bills or legal tender using a cash acceptor or bill reader 16, similar to the kind used with vending machines. The client device validates the acceptance of bills and details the dollar amount accepted in the request message. The cash switch 42 in some configurations may only validate the amount and respond to the ETS 2. Even though this simple check can be carried out in the present ETS system 1, the cash switch 42 may also have a separate utility in other applications.

Enhanced Service Processors

The ETS 2 connects to an enhanced service processor or ESP's 26 for each enhanced service to be sold at the financial terminal device or kiosk 5. The ETS 2 preferably has a standard message format to be used for all enhanced service processors 26, which details the item or service to be purchased, dollar amount, etc. A new ESP 26 may be connected to the ETS 2 for each new service, or to load balance transaction volume if the current ESP resources 26 are overburdened. The ESP 26 may only have to approve transactions by updating a local database or may have an online connection to the end-point organization if real-time approvals are required.

Database Server

Database processing by the database server 35 occurs as part of the back office reconciliation and reporting applications. The primary tables utilized for online processing are:

Terminal ID Information—A master table of Terminal ID records, which holds information such as Terminal ID, Location Name, Address, Fees, etc. A Terminal ID record is retrieved for every incoming transaction to verify the terminal and aid in the processing of the transaction.

Transaction Detail Records—a record for every transaction received by the ETS 2. These records are used to track transactions and will be accessed by the Systems Monitor 37 to research terminal faults and customer inquiries. These records are also used for all back office reporting and reconciliation.

System Monitors

A Systems Monitor application 37 functions to enter terminal information and monitor processing activity. The primary components of the application are:

Terminal Entry—Allows users to enter data for every client device on the network. The record contains information such as terminal owner, location address, fees for services provided, etc.

System Monitoring—Allows network administrators to monitor connections between processors/servers and utilization of the system's resources.

Transaction Monitoring—Allows staff to monitor and review completed transaction activity as well as follow the progress of current transactions.

Architecture

The entire network 1 is scalable to accommodate increases in transaction volume with no alterations to the underlying architecture. The network 1 is extendable to support the addition of new transaction types with little or no change to overall system design.

Scalability is achieved using a message queuing architecture between the components/servers (ETS, ESP, etc) in the network. Application servers interface with each other using common request and response queues. Additional application servers are launched for load balancing purposes or to handle increased transaction volume. Multiple application servers can be operating simultaneously and independently of each other, either on the same or separate physical servers. System uptime is assured by operating multiple application servers for the same service on different physical servers. If one physical server fails, other application servers are unaffected and continue to service requests/responses using the common queues.

Security

Encryption regarding bank cards is regulated by the banking industry. Security is provided at the point of purchase by an encryption device internal to the financial kiosk 5. Use of the internal encryption device can provide security beyond the normal encryption methods.

The banking regulations for encryption presently relate only to the Personal Identification Number (PIN) associated with the bank card. Preferably, additional security is provided so that the entire transaction message is encrypted before it s transmitted to the ETS 2. This encryption can be based on use of the installed encryption device, software algorithms or both. The use of Secure Socket Layer (SSL) methodology can be employed but is not believed to be a necessity for this application, insofar as it may add additional overhead with little beneficial advantage.

Additional security can be added by checking the integrity of the transaction once received. This can be accomplished by validating the serial number of the client device in the ETS database with the serial number delivered in the transaction request.

System Message Types

The following section describes message types used in one embodiment of the invention to request services between all processors, servers, and switches in the ETS system 1. These are exemplary, and are described to aid in understanding the network 1.

Terminal Messages

TRM—Transaction Request Message

This message is used to request the ETS 2 to approve and purchase an enhanced service.

From: Financial Terminal device

To: ETS

Msg Format:

Msg Type | Terminal ID | Transaction Type | Terminal Serial

Num | Pay Type | Pay Amount

IRM—Information Request Message

This message requests information to be routed to a particular Enhanced Service Processor (ESP) 26. The ESP 26 responds after a database lookup table or inquires with an online host. This request is used when information or screens need to be built interactively at the terminal device 5.

From: Financial Terminal/ETS

To: ETS/Service Processor

Msg Format:

Msg Type | Terminal ID | Transaction Type | Terminal Serial Num |

SRM—Server Response Message

Response sent to financial terminal device 5 from a TRM or IRM.

From: ETS

To: Financial Terminal

Msg Format:

Msg Type | Terminal ID | Transaction Type | Terminal Serial Num | Pay Type | Pay Amount

ETS Requests and Responses

FAR—Funds Approval Request/Response

This request is sent to the funds approval switches 11, EFT switch 40, or cash switch 42 to validate the financial portion of a transaction. The message formats may differ between the two financial switches. The EFT switch 40 uses standard banking industry ISO8583 format. The cash switch 42 can use ISO8583 format or an alternative, or a proprietary format.

From: ETS

To: EFT Switch/Cash Switch

Msg Format: EFT Switch—ISO8583

Cash Switch—Msg Type | Terminal ID | Transaction Type | Pay Type | Pay Amount

ESR—Enhanced Service Request/Response

This request is used to approve, acknowledge, or purchase an enhanced service. The system may require the ESR requests to be a different message format for every enhanced service processor 26. The preference is to have one format to function for every enhanced service.

From: ETS

To: Service Processor

Msg Format:

Msg Type | Terminal ID | Transaction Type | Pay Type | Pay Amount

ETS Internal System Data

TDR—Transaction Detail Record

This record resides in memory for the duration of the transaction. The data is used as the source for all request and system messages. The record is written to the database once the transaction is completed. The information is cached or placed into a memory pool in the event of system failure. The memory pool is accessed upon startup to recreate the state of all transactions in progress before the failure occurred.

SSM—System Status Message

This message is sent to systems monitors 37 and details the connection status to every switch 11, enhanced service processor 26, database server 35 and incoming circuit. The message also includes statistics such as transactions in progress and the utilization of resources.

From: ETS

To: Systems Monitor

TPS—Transaction Progress Message

This message is sent to the monitoring stations 37 which details progress of the transaction. The message is sent at every state change of the transaction:

Transaction Request Received

Funds Approval Request

Funds Approval Response

Enhanced Service Request

Enhanced Service Response

Financial Terminal Response

Financial Terminal Completion Received

Final Disposition

From: ETS

To: Monitoring Station

Transaction Flow and Internal Sequence

Transaction Received

1. Retrieve Transaction from queue

Create Transaction ID associated with transaction

Decrypt the request message

Populate request properties in transaction object

2. Request record lookup from database server

Validate message with security check

Populate terminal properties in transaction object

Send Transaction Progress Message (TPM)

Approval of Funds

1. Send Funds Approval Request (FAR) to appropriate switch queue

2. Send TPM

3. Listen to the FAR queue for a response. (Swap between Request and Response queues to retrieve new requests from terminals or responses from financial switches/ESPs)

4. Retrieve FAR Response from queue (if not approved send denial to Financial Terminal)

5. Send TPM

Enhanced Service Purchase

1. Format and send Enhanced Service Request (ESR) to appropriate ESP queue

2. Send TPM

3. ESR Response Received (if purchase denied, reverse transaction to Funds Switch)

4. Send TPM

Response to Financial Terminal

1. Send Server Response Message (SRM) to financial terminal device

2. Send TPM

Transaction Completion

1. Transaction Completion Message (TCM) received from financial terminal device

2. If error occurred, reverse transaction to Funds Switch and reverse purchase to ESP

3. Send TPM

4. Create Transaction Detail Record (TDR) and send to database server

5. Free transaction object from memory

Additional Considerations

The ETS 2 continuously monitors the incoming request queue and all response queues to retrieve messages. There is a response queue for each Funds Approval Switch 11 and each Enhanced Service 26 provided. Multiple ESPs 26 may be running simultaneously for a particular service but all responses are placed in a single queue for that service.

Funds Approval Switches 11 and Enhanced Service Processors 26 must respond to requests within a certain number of seconds. If no response is received, approvals and purchases must be reversed and a denial code inserted in the SRM to the kiosk 5.

Financial Kiosks 5 may request further information from the ETS 2 in order to complete transactions. This is handled by the Information Request Message (IRM), which the ETS 2 will route to a particular server/ESP to handle. This request is used when information or screens need to be built interactively at the financial terminal 5. This feature is incorporated sometime in the future and is not a requirement of the original platform, but the system is designed to easily accommodate this feature when needed.

Multifunction Financial Center (MFC)

An embodiment of a financial kiosk 5 is detailed below and is sometimes referred to as a multi-functional financial center, or MFC, or terminal. FIG. 2 illustrates a block diagram form the major components of the kiosk terminal. A processor unit 14 is programmed to control the various components of the kiosk terminal 5. The processor unit 14 can be of the type having serial and parallel I/O ports, PS/2 or serial mouse port, and other features. The processor unit 14 is coupled to a video display 19 for presenting to the user various types of information and prompts so that financial transactions can be carried out. The video display 19 is equipped with an SGVA touch sensitive screen 20 so that when the user physically touches and presses on an area of the video display 19, the touch sensitive screen 20 detects the same and transmits to the processor unit 14 the coordinates of the area touched. As will be described below, the information input by the user vial the touch screen 20 is encrypted by an encryption/decryption processor 23 to provide a high degree of security to the financial transaction.

The processor 14 controls one or more media printers 21 which can be a receipt printer, a ticket or coupon printer or other printers for printing money orders, vouchers, negotiable instruments and other papers having value. The kiosk terminal 5 of the preferred embodiment is also equipped with one or more cash or currency dispensers 18 for dispensing cash or currency at the kiosk terminal 5. The currency dispensers 18 are of conventional design. The kiosk terminal 5 has built therein a currency acceptor or bill reader 16 of conventional design that can accept and verify the authenticity of thirty-two different types of domestic and foreign currencies. Included also is a magnetic card reader/writer and dispenser 17 for reading ATM, credit, debit, smart and other types of magnetic strip cards. The dispenser 17 can also write on the magnetic strips or chips of such cards, for example smart cards to change the balance thereof. In addition, the apparatus 17 can write on new card stock stored in the kiosk terminal 5 to dispense calling cards, and the like. Magnetic card stock would be stored in the terminal 5 when equipped with this feature. The kiosk terminal 5 may optionally be equipped with optical scanners, RF transceivers, infrared communications equipment, check readers/printers, depository printer components, a signature pad, coin acceptors/dispensers, biometric fingerprint, iris or facial scanner, and other equipment that may facilitate financial transactions.

An encryption/decryption processor 23 communicates with the kiosk processor unit 14 for encrypting and decrypting data received from the touch screen 20. The kiosk processor unit 14 encrypts and decrypts data respectively transmitted and received via the communication ports 22. As will be described in more detail below, encrypted transaction messages are transmitted (and received) by the kiosk terminal 5 to a network transaction server 72.

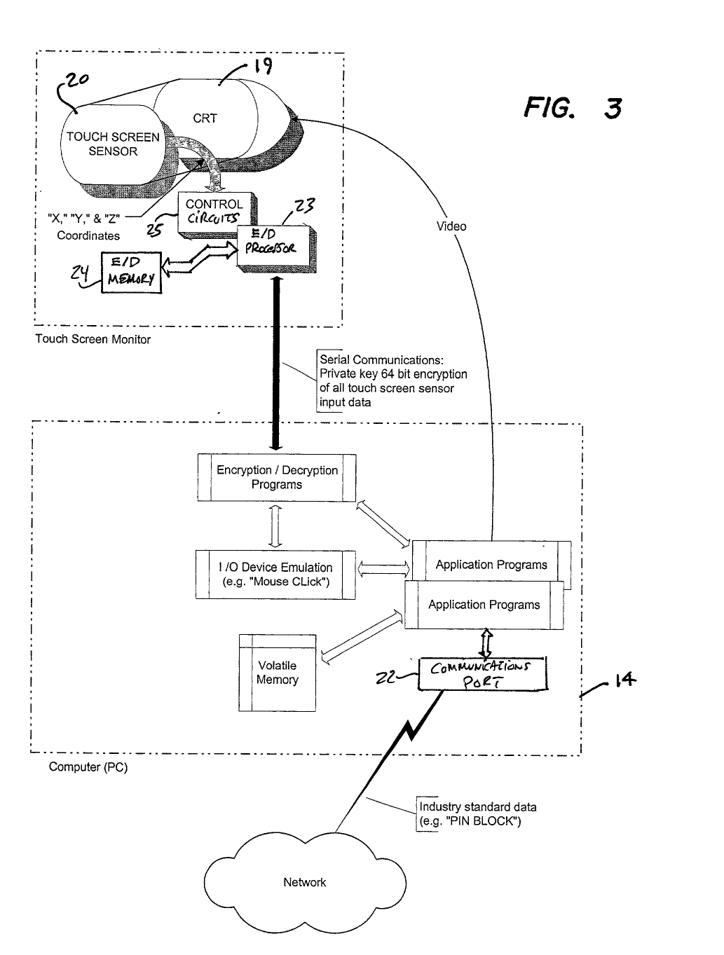

In accordance with an important feature of the invention, user inputs to the kiosk terminal 5 are all encrypted to provide a greater degree of security to the financial transaction, than heretofore afforded. FIG. 3 illustrates the components in the kiosk terminal 5 that function to carry out such a feature. The touch screen apparatus 20 is of conventional design for attachment directly to the face of the CRT display 19. The processor unit 14 drives the CRT 19 with video signals for presenting text and graphic displays on the CRT. When the user is instructed via text on the CRT display to make a choice, such as a method for payment for purchasing goods/services, paying a bill, etc., the user can press on the area of the CRT display 19 to make a selection, whereupon the touch screen apparatus 20 detects the pressure of the user's finger and produces the x and y coordinates of the area touched. In addition, the touch screen apparatus 20 produces a z-axis value that corresponds to the extent of pressure applied by the user to the touch screen 20. The z-axis values are within a range of 256 values (0-255), with a zero value corresponding to no touch, and values 1-255 corresponding to a touch of varying degrees of pressure. Those skilled in the art may determine that the absence of a recognized touch may constitute z-axis values of 0-50, and a touch may constitute z-axis values of 51-255. Many other combinations of z-axis values may be optional for ascertaining when a user has intentionally touched the touch screen 20. While the preferred embodiment utilizes the z-axis value of the touch, the use of the same is not essential to the practice of the invention. Rather, the parameters, whatever are chosen, that represent the area of the CRT 19 that is touched are what is necessary to convey to the D/E processor 23 for encryption.

The x/y coordinates and the z-axis value of the touch are converted to data which is coupled to control circuitry 25 of the encryption/decryption (E/D) processor 23. Accordingly, each and every touch of the touch screen 20 by the user of the kiosk terminal 5, including the PIN input by the user, when employed, is converted to data that is coupled to the E/D processor 23. The E/D processor 23 encrypts the touch screen data according to any encryption algorithm, and passes the encrypted data to the kiosk processor unit 14. In the preferred form of the invention, the Data Encryption Standard (DES) algorithm is utilized. To that end, a private key 64-bit encrypted word is transferred for each touch from the E/D processor 23 to the kiosk terminal processor unit 14. Importantly, by also encrypting the z-axis value, which varies from 1-255, the encrypted word is much more secure, in that it is extremely difficult to decode without knowledge of the encryption key. This feature of the invention can be used in environments other than for financial transactions, such as in secure environments where workers must input to a touch screen a security code in order to gain entrance to a secure area. Many other applications are available for use of this feature of the invention.

In a preferred form of the invention, the E/D processor 23 and memory 24, and other circuits, are mounted to a printed circuit board and the entire assembly is potted or otherwise encapsulated with a tough and impenetrable material to render the assembly physically secure. This makes it difficult to attach wires the circuits to determine the encryption/decryption algorithms, or determine the data coupled from the touch screen 20 to the E/D processor 23. The memory 24 coupled to the E/D processor 23 stores the encryption/decryption key and algorithm. It is noted that both the processors 14 and 23 access the same memory to obtain the data for encrypting and decrypting data. Thus, both processors use the same algorithm. However, only the kiosk processor unit 14 accesses the memory 24 to obtain the decryption algorithm, as such processor decrypts the encrypted data it receives from the E/D processor 23, and decrypts the data it receives from the financial network.

As noted above, the E/D processor 23 transmits encrypted data to the kiosk processor unit 23. On receipt of the encrypted data, the kiosk processor unit 14 decrypts all such data. The data that is considered sensitive, such as a PIN or other data that will become a part of the transmission message 200 to the transaction server 72, is trapped and again encrypted. This encryption is carried out by the kiosk processor unit 14 accessing the memory 24 via the E/D processor 23 to obtain the encryption algorithm. The data received from the E/D processor 23 that is not sensitive is not again encrypted, but rather is converted to a “mouse click” and applied to the application program. The nonsensitive data may be an input by the user touching the touch screen 20 to proceed to the next menu, whereupon the application program presents the next menu on the CRT 19 for display to the user. As can be seen, the nonsensitive data need not be secure, and does not eventually find its way into the transmission message 200.

While the foregoing illustrates a technique for transferring data in a secure manner from a touch screen 20 to a processing system, those skilled in the art can readily appreciate that a similar technique can be utilized in transferring data in a secure manner from voice-activated apparatus to a processing system. In such a technique, most, if not all, of the data converted from voice signals to digital signals would be encrypted, and from such data the sensitive data would remain encrypted, or be encrypted again for subsequent transmission. The nonsensitive data would not have to be encrypted again, but could be processed as normal data.

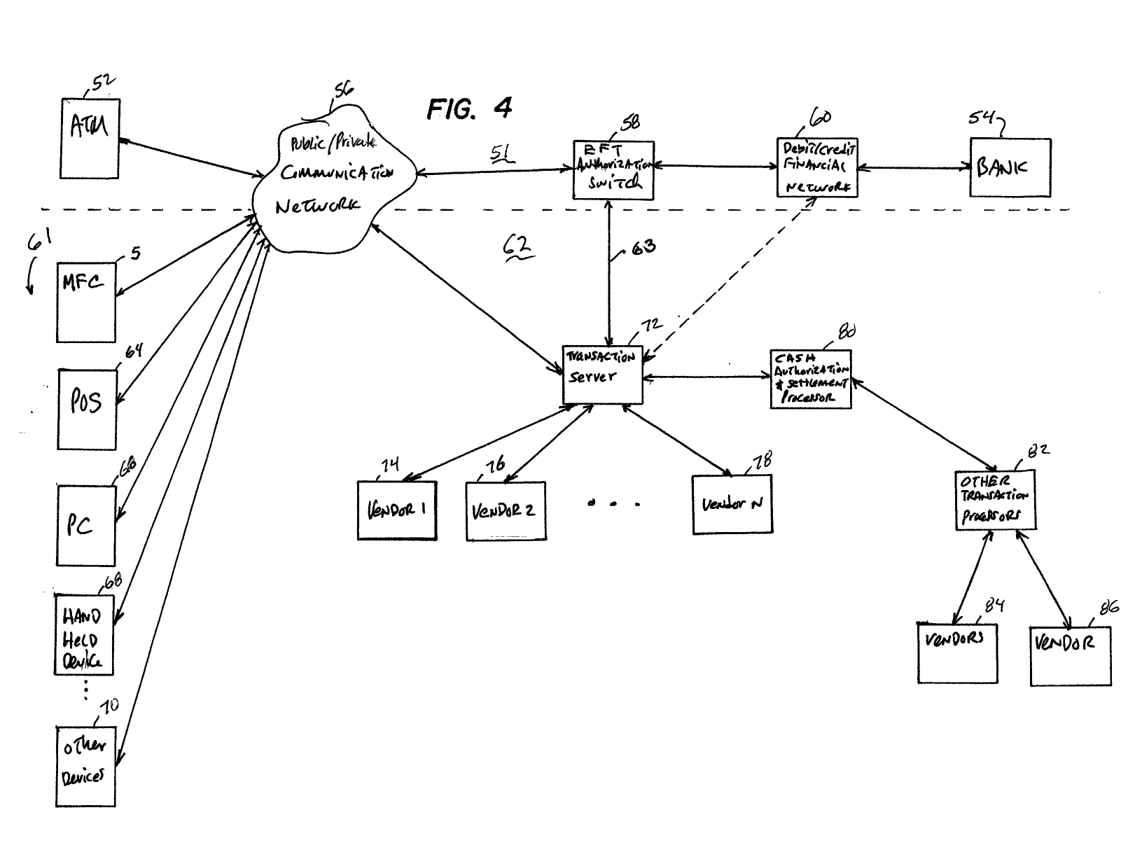

When sufficient information has been collected by the kiosk processor unit 14, a transaction message is formatted, with the encrypted, sensitive data, and transmitted to a network transaction server 72 (FIG. 4), via the communication port 22. The memory 24 can be shared by both of the processors 14 and 23 for storing and using the encryption/decryption algorithm. Hence, the same DES algorithm is used in both encryption/decryption processes. When it is desired, for example, to purchase a calling card from the kiosk terminal 5, numerous prompts will be provided to the user by the processor unit 14 to determine that a purchase is desired, a specific purchase of a calling card, and the value amount to be written on the calling card. Next, other prompts will be provided to the user to determine the method of payment for the calling card, i.e., whether cash, smart card, credit card, etc., will be employed by the user as the method of payment. When this information is collected by the processor unit 14, a transaction message is formatted and transmitted in encrypted form to the transaction server 72. If the method of payment is validated, then a calling card is prepared and dispensed to the user at the kiosk terminal 5. The method of payment can be verified by verifying that a sufficient amount of cash has been inserted by the user into the bill reader 16, that the user's bank account has sufficient funds if payment by credit card or debit card was chosen, or if a smart card had stored therein an indication of sufficient funds to cover the cost of the calling card if this was the chosen method of payment. When dispensing calling cards, the kiosk terminal 5 would download from the transaction server 72 a block of unique number that can be used when dispensing the calling cards. Such numbers would be assigned by a calling card vendor to the transaction server 72. The calling card numbers serve to identify transactions carried out by the calling card user, and to provide a means of settlement of charges.

The same type of financial transaction can be carried out when a user desires to purchase a money order form the kiosk terminal 5. In this situation, a method of payment would be chosen for obtaining a money order printed by the printer 21 of the kiosk terminal 5. Again, a block of numbers would be downloaded to the transaction server 72 by a money order vendor, and such numbers would be sequentially printed on money order stock by the printer 21 in the kiosk terminal 5. A check reader can be employed in the kiosk terminal 5 for receiving a payroll, or other type of check, and dispensing cash by the currency dispenser 18. The user can provide payment by many means to the kiosk terminal 5 and provide input information so that the processor unit 14 causes a ticket to be printed. The ticket can be for a performance, exhibit or a pass to any type of activity. In addition, goods and/or services may be purchased and invoices or bills paid through the kiosk terminal 5, whereupon a receipt can be dispensed or printed to function as a voucher or receipt to present to the vendor that payment has been made for the goods/services or bill. Many other types of transactions can be carried out, as described in more detail below.

The present invention according to one embodiment thereof has developed technology, apparatus, methods, integrated systems, and business methods for providing a system of accepting any form of payment, not limited to cash, coins, bank draft, credit card, debit card, stored value card (smart card or prepaid magnetic cards), electronic or any other form of cash value from one unattended electronic data capture device and thereafter transferring, converting or exchanging the input value received at the local device to an unlimited number of products and services that may be dispensed, printed or transferred to any form of acceptance at the local device (device of value input), to a second device located within the domestic United States or to a foreign device located within another country.

A concept of the invention comprises a number of components, proprietary software and other elements to accomplish capturing the cash or stored value from an unlimited number of resources including and not limited to other forms of payment that would ultimately be converted or transferred to other instruments of monetary value (representing currency, legal tender or a governmental obligation), product or service and be credited to another form of acceptance and printed on one or various forms or any form of media, either in whole or in part.

The MFC 5 is designed to convert any form of payment (both manual and electronic) and exchange, transfer or dispense the same, discounted or similar value to a point of acceptance, to any other products or services at the local MFC 5, in another MFC 5 located within the domestic market in the same country or to transfer and exchange the value of payment to another country for acceptance.

The MFC terminal accepts currency, cash, coins, negotiable instruments or obligations of a government in the geographic local or domestic area (the “obligations”), or the like, and can convert or exchange the value of the currency into another form of acceptance or obligation value.

The MFC terminal accepts an obligation at the local MFC, request from the user the country of destination (either local or foreign), performs an exchange rate calculation (if the currency is to be dispensed in the same country, then the exchange rate calculation is not performed), notifies the User of the fee charged for the transfer, then the customer or user inserts the local obligation into the currency acceptor. The MFC terminal then provides a receipt for the transaction being undertaken and transmits a formatted message to the host processor. In the event the customer or user is to receive an amount determined to be change (or coins) resulting from the transaction, then the MFC terminal generates a money order in the amount of the change and completes the transaction with a receipt of the amount transferred for the user's records. The user then telephonically, facsimiles or otherwise notifies the recipient of the transfer and reports a receipt number or transaction number and a Personal Identification Number to the recipient. The recipient then goes to another MFC or ATM (if, the ATM in the foreign destination has been certified within the processor system) at the destination and request to receive a transfer. The recipient then enters the transaction number and the PIN number, whereupon the MFC or ATM at the destination dispenses the equivalent amount of obligations, less adjustments from any currency devaluations from the date in which the original transaction was transmitted by the user, to the date in which the obligation has been dispensed (with the exchanged rate calculated being calculated on foreign transactions). Upon completion of the transaction to the recipient the destination MFC or ATM prints a receipt indicating the net value received.

The kiosk terminal in one embodiment can include, but not be limited to one or more electronic components, including and not limited to a PC based computer system (w/Intel Pentium II, III, AMD or equivalent processor, 64KB or more Read Access Memory, CD-ROM, 1.4 mb floppy disk drive, 2 GB or greater capacity hard disk drive, (serial, parallel, and UMB I/O ports), DES (Data Encryption Standard) or TDEA (Triple Data Encryption Algorithm) encryption card or similar hardware, firmware, or software encryption mechanism, super video adapter, any size color touch sensitive screen display or color display monitor, keyboard, ps/2 or serial mouse, stereo audio adapter, receipt printer, a media writer/reader (Magnetic, Smart Card or other reader/writer device) and or dispenser, including and not limited to currency, cash, or coin dispenser(s), negotiable instrument printers and or acceptance devices such as currency or other components that accept any method of payment(s) incorporated or encapsulated in an enclosure where all negotiable instruments including any financial institution or government obligations are enclosed within an industry rated safe enclosure and therein all components together are enclosed within a kiosk.

With reference now to FIG. 4, there is illustrated a block diagram of a financial network for transferring value in electronic form, from one geographical location to a different location. The diagram of FIG. 4 illustrates many components and systems of a banked network 51 that is presently utilized for completing electronic funds transactions. To that end, the present electronic funds transfer network includes, for example, an ATM 52 for dispensing cash. The typical ATM transaction is a “banked” transaction, in that a bank 54 is necessary for completion of such type of transaction. In order for a user of the ATM to initiate a transaction, such as a request to dispense cash and debit his/her bank account, the user swipes the ATM card in the card reader of the ATM, and enters the PIN and the amount of cash to be dispensed. In practice, the ATM employs a keypad for entry of the PIN or password. The data entered by the user via the keypad is encrypted to provide security to the transaction. The ATM machine 52 encodes this information into a standard message format. The ATM communicates via a recognized protocol, such as the well known ISO8583 protocol. The messages from the ATM machine 52 are communicated to an Electronic Funds Transfer (EFT) authorization switch 58, via a private, or any other communication network 56. There are many businesses that provide services in connection with the EFT authorization switch 58. The EFT authorization switch 58 decodes the message and determines the destination thereof, based on various fields of the message. The EFT authorization switch 58 is programmed to carry out many types of banked transactions, but not unbanked transactions. In any event, the ATM a message is then dispatched to a debit/credit financial network 60, of which there are many available for such purpose. The message concerning the ATM transaction is passed from the debit/credit financial network 60 to the destination, namely a bank 54 associated with the bank card the customer is using. The bank 54 determines whether the person requesting cash from the ATM 52 has sufficient funds to cover the transaction. If not, then the bank 54 dispatches a message back to the ATM 52 via the network that the request is declined. If the transaction can be carried out, the bank 54 routes data back through the network to the ATM authorizing the dispensing of the cash. Lastly, the EFT network described above settles the transaction by allocating a prescribed amount of money to the various systems involved in the transaction, as fees for the services rendered. The bank 54 may also debit the user's bank account with the corresponding service charge for completing the transaction.

While the present EFT network 51 can accommodate banked transactions in a well established manner, unbanked transactions cannot thus far be carried out by such a network 51. FIG. 4 illustrates various user-oriented devices 61 for requesting many types of transactions in an unbanked transaction network 62 that is configured to accommodate such type of transactions. Moreover, the unbanked network 62 includes an internetwork connection 63 to the banked network 51 to thereby integrate the unbanked service with the banked network 51, when the need arises.

The user devices 61 adapted for requesting unbanked services may include the multi-functional financial center (MFC) 5 described above, a pont of service (POS) device 64, a personal computer 66, a hand-held device 68 or many other types of devices 70 that can interact with a user to request services with the unbanked network 62. Any request from a user device 61 is transmitted as an encrypted message to a transaction server 72, such as the electronic commerce transaction server (ETS) 72 described above. Once received by the transaction server 72, the message is decrypted and processed.

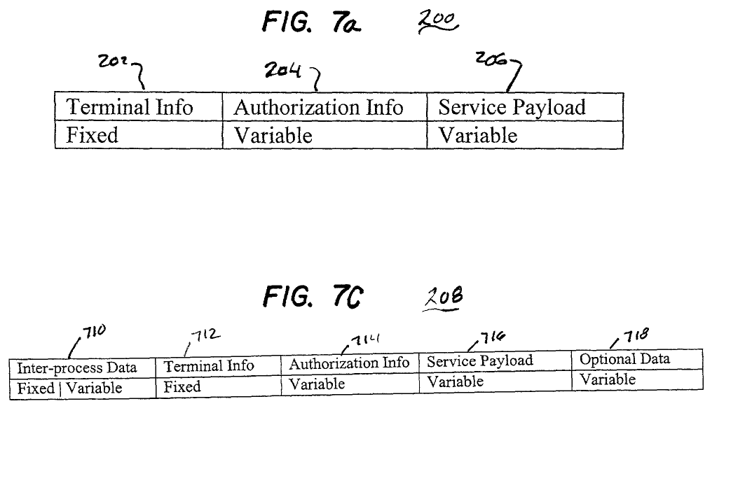

The particular unbanked transaction message format employed in the preferred form of the invention is described in more detail below in connection with FIG. 7. The specially formatted message includes three segments for efficiently transmitting information between the devices 61 and the transaction server 72. A device information segment of the message uniquely identifies the device 61 from which a request was input by the user. The device information segment also includes other device information, as well as a field indicating the format of an authorization segment, and a field indicating the format of a service payload segment. The authorization segment of the message includes a number of fields, one of which is a field indicating the method of payment for the transaction. A service payload segment of the message includes a number of fields, one of which includes a field indicating the vendor from which goods or services are requested by the user.

The message generated by the user device 61 is received by the transaction server 72 which decodes the three segments and processes the request accordingly. If the authorization segment indicates that the transaction is to be funded by a banked transaction, such as a credit card, then the transaction server 72 transfers a corresponding request to the EFT authorization switch 58. The request is then transferred to the appropriate bank 54, authorized or not authorized, in the manner described above, and a response is sent back to the transaction server 72 by way of the internetwork connection 63. If the banked payment method is authorized, then the transaction server 72 uses the service payload segment of the request message to determine what goods/services were requested by the user. The transaction server 72 also decodes various fields of the service payload segment of the message to find the vendor identified therein. The transaction server 72 can be electronically connected to the various vendors, shown in FIG. 4 as reference numerals 74, 76 and 78. The vendor identified in the service payload segment is accessed by the transaction server to complete the transaction requested by the requester. The transaction server is programmed to inquire with the various vendors as to whether the goods/services are presently available, the price, quantity, etc. The transaction server 72 sends a message to the device used by the user to confirm that the goods/services have been purchased. Lastly, in this banked example of internetwork activity, the transaction server 72 settles the transaction by causing funds to be transferred from the bank 54 to the vendor identified in the message. The funds can be dispatched from the bank 54 to the vendor's account by standard Automated Clearing House (ACH) techniques, or other methods of electronic funds transfer. As will be described below, the user device is configured to provide the user with various prompts via a touch screen for eliciting the information necessary to complete the transaction. For example, if a bill or invoice is to be paid, the user device automatically prompts the user as to the utility company, account number, the amount, etc., and other information that must be input by the user via the touch screen display. The transaction server 72 receives such information in the message and can coordinate the actions necessary in order to verify that sufficient funds are available, that the order is placed, that confirmation of the same is received, that the funds are transferred to the vendor, and that those providers in the transaction chain are appropriately paid for the use of the services involved.

In addition to the foregoing, numerous other goods/services can be purchased by users of the user devices 61. For example, the user of a device 61 can input appropriate information to indicate a method of payment for purchasing an airline ticket, a bus ticket, a ticket for an entertainment performance, pay a fine, purchase a license, etc., whereupon the funds are collected by the transaction server 72 and the user device 61 would be enabled to print a ticket for the user or otherwise confirm that the money made available by the user has been applied to the goods/services purchased. In these transactions noted, the transaction server 72 would also access the appropriate business or vendor that normally issues such type of ticket and determine if such a ticket is available, the price, a sequence number for the ticket and any other pertinent information for printing an authentic ticket, or receipt indicating proof of purchase/payment.

In the event the message decoded by the transaction server 72 indicates payment by unbanked means, such as a smart card, cash, etc., the transaction server 72 can proceed to complete the transaction in the unbanked network 62, independent of the banked network 51. Not all input devices 61 may accommodate the input of cash, and thus the user can easily input the digits of, or swipe a smart card in a reader to thereby initiate an unbanked transaction. Moreover, the user of the device 61 can employ any of the unbanked methods of payment to purchase any of the goods/services as a person using a banked method of payment. In any event, if a user desires to purchase a ticket of some kind or pay a utility bill, then an indication of the same is input via the touch screen of the MFC 5, or other input means provided by the device 5. When prompted as to the method of payment, the user will indicate “cash” on the touch screen if this is the chosen method. The user can also indicate on the touch screen that a ticket is to be purchased, or a bill paid, as well as the applicable vendor, and the goods/services to be purchased. The MFC device 5 encodes this information in the appropriate message format segments, encrypts the same and passes the encrypted message to the transaction server 72. The transaction server 72, in turn, forwards an appropriate message of a specified protocol to the cash authorization and settlement processor 80. The processor 80 logs in the cash transaction and other information to identify the particular transaction. Next the transaction server 72 accesses the appropriate vendor of the ticket, or the utility company identified in the information encoded in the service payload segment of the message. The vendor is queried as to the quantity of the goods, services, and is provided with information as to the particular ticket(s) to be purchased, or the invoice to be paid.

Because a number of service providers are involved in the unbanked transaction, a service fee is charged the user for completing the unbanked transaction. The owner/operator of the input device 5, especially if it is of the kiosk type is entitled to a fee for the use and convenience of using the same by an unbanked person. In addition, the operator of the transaction server 72 and the cash authorization and settlement processor 80 receive a fee for the use of the services provided by such systems of the unbanked network 62. To that end, the service charges are similar to those assessed to the user when using the various services of the banked network 51. Accordingly, the transaction server 72 adds the service fee to the cost of the goods/services to be obtained, and sends a message to the MFC 5 indicating to the user the total amount to be deposited with the device 61.

In response to the indication to the user of the amount to be deposited in the MFC 5, the user proceeds in depositing the requisite amount of cash, to the nearest dollar (or foreign denomination) over the required amount. The excess cash deposited is returned to the user by way of the printing of a negotiable instrument, such as a money order, a scrip or voucher. Of course, those skilled in the art may desire to return the overage in the form of coins dispensed to the user from the device. Coin changers are well known and can be used for that purpose in the MFC 5. The MFC 5 is equipped with a bill or currency reader for verifying the authenticity of the currency input thereto, and the denomination of the bills. The user is also provided with a readout on the touch screen display of the cumulative amount of currency deposited for the transaction. The user can touch the touch screen when he/she desires that the transaction proceed once the requisite amount of cash has been deposited in the MFC 5. The information concerning the amount of cash deposited is encoded in a message which is transferred to the transaction server 72. The transaction server 72 transports a further message to the cash authorization and settlement processor 80 for confirming that a specified amount of cash has been deposited by the user in the MFC 5. Since each input device of the unbanked network 62 has a unique identification number, the cash authorization and settlement processor 80 can maintain a record of the cash deposited in each device 61. Once the requisite funds have been deposited by the requester, and placed on record by the cash authorization and settlement processor 80, the transaction server 72 will again accesses the appropriate vendor, such as vendor 74, 76, 78, etc., to purchase the ticket or pay the utility bill. If a utility bill is being paid in this exemplary cash transaction, then the utility vendor marks its records accordingly. In practice, it is envisioned that utility payments to the various vendors will be batched by the cash authorization and settlement processor 80 and dispatched once per day. If a ticket is to be purchased, then the ticket vending business is accessed to purchase the ticket, in which event the ticket number and other information is passed from the ticket vending business to the transaction server 72. The ticket information is then passed by the transaction server 72 to the MFC 5 which proceeds in printing the ticket.

In the settlement of the cash transaction, armored security personnel collect the cash from each MFC device 5 on a periodic basis, such as every other day. The cash is counted and deposited in an account associated with the cash authorization and settlement processor 80. Each MFC device is associated with a unique identification number and the cash deposited in the account is also associated with the MFC ID number. The cash authorization and settlement processor 80 periodically access its account to determine what proceeds have been credited thereto. The funds in the account are disbursed by the cash authorization and settlement processor 80 in a FIFO manner to the various vendors. In other words, the cash deposited in a MFC device 5 is first used to pay the vendors having the oldest underlying credits registered with the processor 80. The vendors are paid by electronic transfer of finds, such as by using ACH techniques. In addition, the cash authorization and settlement processor 80 transfers funds in payment of service provider fees to the accounts associated with the input devices 61, if necessary, and the transaction server 72. Because the cash authorization and settlement processor 80 provides a vital service in the unbanked network 62, it also reserves for itself a service fee. As noted above, for cash transactions and other unbanked transactions, all service fees are added to the cost/price of the goods/services and paid by the user before the transaction is completed. The credit worthiness of the user is thus irrelevant in the unbanked transactions. (Some of these fees may already be absorbed by the profit margin of the item being sold.

The unbanked financial network 82 can accommodate third party systems providing kiosks and similar devices that accommodate unbanked transactions. The processor associated with such third party devices can be connected to the cash and settlement processor 80 so that settlement of the transactions can be accomplished. In all respects, the third party processor 82 functions much like the transaction processor 72.

While the foregoing banked devices (ATM's and other devices) and unbanked devices 61 are shown as separate devices operating in the two networks 51 and 62, the input devices can provide both banked and unbanked services. Also, the financial networks 51 and 62 themselves can be integrally integrated so that the same switches and/or processors can service both banked and unbanked transactions.

While the foregoing sets forth the basic operations using cash as a method of payment, the user can also use other unbanked means such as a smart card. When a smart card is employed, the user notes the same on the touch screen of the MFC device 5, and instead of requesting the user to insert cash, the device instructs the user to insert the smart card, whereupon the balance thereof is read by the device, and if sufficient funds are available, the cost of the goods/services (plus the service fees) is deducted from the card and a new balance is written to the card. Smart card reading/writing equipment is conventionally available. A similar type of transaction is carried out by the input device if the method of payment is indicated by the user to be a debit card.

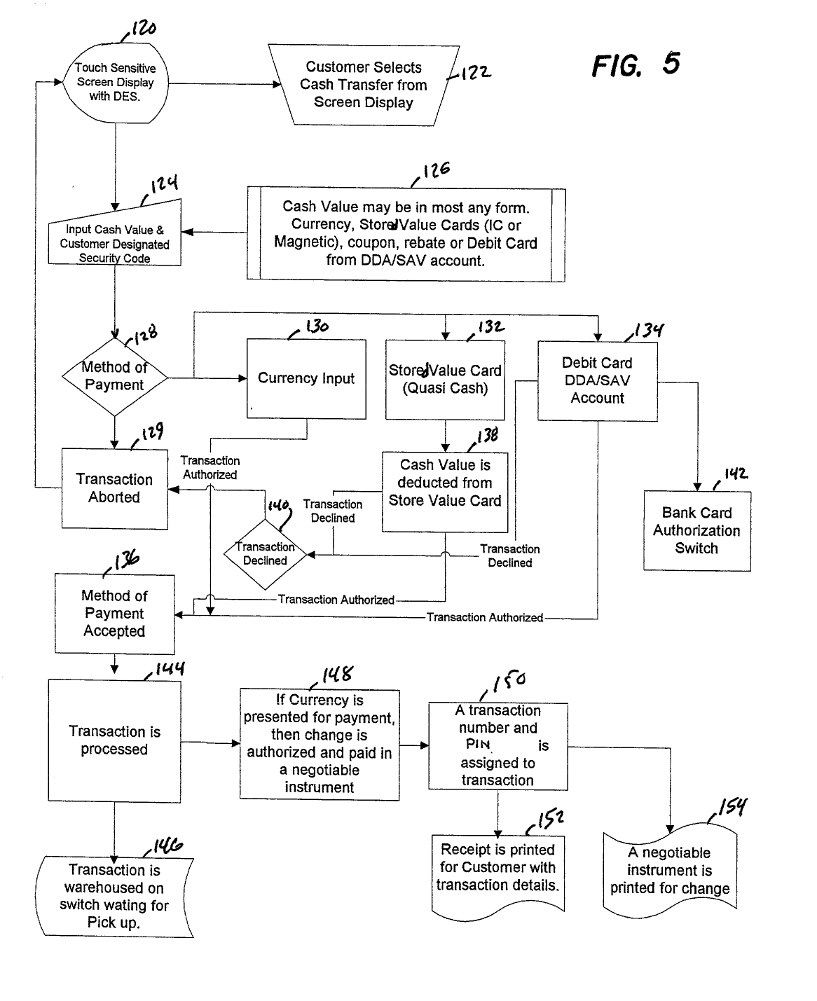

FIG. 5 is a detailed flow chart depicting the process flow of the data and information in completing an unbanked transaction, using a device 61 at an origin that is unattended. By unattended it is meant that the user of the origin device initiates the transaction himself/herself without the assistance of another person located at the origin device. Once cash is deposited at the origin device, the cash (less the service charges) is made available for dispensing at a destination device that is geographically remote from the origin device. The destination device can be a MFC device 5, an ATM or other device that is capable of communicating with a financial network, and capable of dispensing cash. The destination can also be a business and have a method of verifying the transaction and having a person employee/employee to physically hand the value of the transaction to the recipient (such as a post office). Indeed, legal tender in the nature of dollars can be deposited in an origin device 5 in the United States, and legal tender in the nature of Pesos can be dispensed from a destination device in Mexico. Cash can effectively be transferred from one location to another without the intervention of a bank This is advantageous in many instances where the user need not have a bank account, nor have a credit history.

In block 120 the user of the origin device 5 is provided on a screen a visual menu of the various options for initiating a financial transaction. In accordance with a preferred form of the invention, the user selects (block 122) via a touch pad or touch screen on the origin device 5 a transaction in which a cash or legal tender transfer is to be the basis of the transaction. The user can also select on the touch screen the payment option of debit card, stored value card, or other type of unbanked payment medium. If the cash option was selected, the user also inputs the amount of cash to be transferred. The input device 5 adds to this amount the service fees involved and returns to the user a display of the total amount to be deposited in the device 5. The user then inserts bills of legal tender in the specified amount in the origin device 5, as shown by block 124. A conventional bill acceptor is utilized to determine the authenticity of the currency and the denomination thereof. The origin device 5 is programmed to count the currency input by the user and provide on the visual display the cumulative amount. In addition, the user may optionally insert in the origin device 5 a predesignated security code. Optionally, if the transaction is to be carried out using a medium other than legal tender, then the user is prompted to swipe his/her stored value card, debit card, or other input medium having associated therewith a value. This is shown by block 126.

The method of payment input by the user is determined by the origin device 5, as shown by decision block 128. In the event that the origin device 5 determines that the method of payment is invalid or otherwise cannot be carried out, then the transaction is aborted, as noted in block 129. If legal tender is input into the origin device 5, then processing proceeds to block 130 where the currency is accepted by a bill reader. Here, the validity or authenticity of the currency is determined by conventional techniques. The denomination of the currency is also determined.

Processing from decision block 128 proceeds to block 132 if the user elects to initiate the financial transaction using a stored value card. Similarly, if the user elects to use a debit card for the transaction, then processing branches to block 134.

From block 130, if the legal tender inserted into the origin device 5 is authenticated, the method of payment is accepted, as noted in block 136. If the stored value card is used (blockl32), the cash value of the transaction is deducted from the card, and the remainder or balance is written back to the card. This is shown in block 138 of FIG. 5. If an insufficient value remains on the stored value card such that the transaction cannot be carried out, then processing branches to block 140 where the transaction is declined and thus aborted. On the other hand, if the stored value card has stored thereon sufficient funds to carry out the financial transaction, then the method of payment is accepted, as noted in block 136.

Lastly, if a debit card is used to initiate the financial transaction, then processing branches to block 142 where access is made to the bank card authorization switch 60, via the transaction server 72. Here, the transaction is either authorized, or not authorized. If the bank card authorization organization authorizes the debit of funds from the debit card, processing branches to blocks 136, and if the transaction is denied, processing branches to block 140 and 129 where processing of the transaction is aborted.

When any of the methods of payment of the financial transaction is accepted by the origin device 5, the transaction is processed. This is noted in block 144. Various aspects of the transaction are warehoused (block 146) for later accessing when a recipient at a destination device desires to conclude the financial transaction by delivery or dispensing the value of the transaction at the destination device. At the option of the recipient located at the destination device, the value of the transaction can be dispensed by means of legal tender, by writing to a stored value card for crediting funds thereto, or by numerous other means by which the user at the destination can employ the transferred value freely in the marketplace.

Program flow block 148 is carried out if there is a difference between the value of the funds electronically transferred to the recipient and the value of funds input into the origin device 5. Here, the difference is refunded to the user by way of the printing of a negotiable instrument, such as a money order. The refund is printed and/or dispensed to the user at the origin device 5. A transaction number and a PIN number are assigned by the origin device 5 to the transaction server 72. The transaction number and the PIN number are printed on a receipt at the origin device 5 as a record of the transaction. This is shown by block 150. As will be described below, the transaction number and the PIN number are transmitted by any available means by the user to the recipient located at the destination, whether it be a domestic or international location. Typically, the user can convey this information to the recipient by telephone, email, fax, postal or expedited delivery, or any other spoken, written or electronic means. The receipt is printed and presented to the user at the origin device 5, as noted in block 152. As noted in block 148, the transaction may necessitate a refund of change to the user. This often occurs when the amount of currency or legal tender input into the origin device 5 cannot be reconciled with the exact value to be transferred to the recipient. If change results from the transaction, the negotiable instrument is printed, and shown by block 154.

As can be appreciated from the foregoing, the operations at the origin device 5 are fully initiated and completed by the user without assistance by an attendant. In those situations where an attendant is provided, the foregoing process flow can be modified in the following manner. The process flow block 126 may be representative of the operations where the user hands or otherwise delivers to the attendant the cash, the stored value card, etc., for input of the requisite value into the system. In addition, if change is required, as determined in process flow block 148, then block 154 may be modified to include the operations where the attendant hands or otherwise delivers the change to the user.

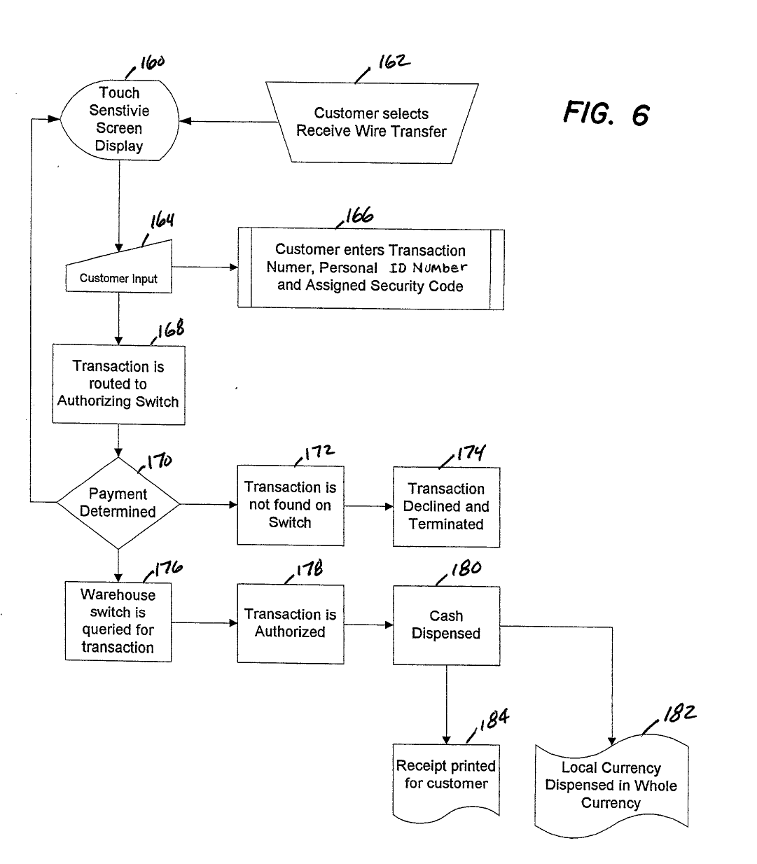

FIG. 6 is a process flow diagram of the operations by the destination device for dispensing to the recipient the value electronically transmitted from the origin device 5. It should be understood that the origin and destination devices are preferably configured to function as both origin and destination devices. In process flow block 160, the processor of the destination device monitors the touch sensitive screen to determine if any of the symbols thereon have been touched or depressed. Certain of the symbols on the touch screen allow the recipient to select a receive wire function, as denoted in block 162. When such symbol has been selected by the recipient (block 164) the recipient enters into the destination device via the touch screen the transaction number, PIN number, and the optional security code if elected by user of the origin device 5. This is noted in process flow block 166.

In accordance with the operations of the destination device shown in process flow block 168, the transaction is routed to the cash authorization and settlement switch 80. This routing may involve one or more telecommunication systems or networks in order to transfer the transaction between the origin and destination machines. In any event, a determination is made (decision block 170) as to whether payment should be dispensed at the destination device. If the transaction cannot be found in the origin switch, as shown in block 172, then the entire transaction is declined or terminated (block 174).

As described above, transactions initiated at the origin device 5 are archived or warehoused (block 146 of FIG. 5) so that when later accessed, it can be verified that the transaction is bona fide. If the transaction has been previously registered with the origin device 5 (block 176), the transaction is authorized, as shown in block 178. Once authorization has been verified, the value of the transaction is dispensed or made available for use by or on behalf of the recipient. In the example, legal tender is dispensed (block 180) at the destination device to the recipient. The local currency is preferably dispensed (block 182), and a receipt for the transaction is printed and provided to the recipient (block 184). While local currency is generally dispensed, those skilled in the art can equip the destination machine with the appropriate secure printers, ink and paper to print negotiable instruments, vouchers, scrips, etc. of other countries. In this manner, value can not only by transferred, but it can be automatically exchanged into currencies other than the currency of the country in which the destination device is located.

In other situations, the value can be dispensed to the recipient by printing a negotiable instrument, printing a ticket (sports event ticket, bus or train ticket, etc.), printing a coupon, printing a merchant gift certificate, printing a license or other document. In yet other situations, the value dispensed at the destination machine can be in the nature of writing on a stored value card, or crediting other types of cards by writing on the magnetic strips thereof. The dispensing of value at the destination machine can be the electronic transfer thereof to a bank account; to a merchant to automatically and electronically pay a bill, purchase goods and/or services; to pay governmental fees and taxes, penalties and fines, and a host of other things.

Transaction Message Formats

The origin device 5 and the destination device are programmed and configured to provide electronic fund transfer communications with the respective service switches. These communications are secure, in that the transaction messages are encrypted at the source and decrypted at the destination. The transaction message formats generally comply with the ISO 8583 format. In general, there are request messages and response messages in order to complete a transaction.

The unbanked transactions described above involve the deposit in a user device 61 of value useable in the unbanked network 62. As can be appreciated, the method of payment can be of various mediums, and the goods/services and corresponding vendors are even more diverse. However, all of these parameters are specified in the message transmitted between the user devices 61 and the transaction server 72 (FIG. 4). If one were to use a conventional transmission format having a field for each different parameter, the number of bytes in the message would be unacceptably large, and many of the fields would not be used for every transaction. Accordingly, a new transmission format according to another embodiment has been developed to accommodate a very large number of parameters, but the number of fields for each financial transaction remain at a nominal level.

In accordance with an important aspect of the invention, the transmission format used between the user device 5 and the transaction server 72 has various segments, a fixed segment of which has a field that identifies the particular makeup of a variable authorization segment. For example, when the one field of the fixed segment has the identifier 400 this means that the variable segment of the message has fields specially used for a cash transaction. Similarly, another field in the fixed segment specifies the type, size and layout of the service payload segment portion of the message. Thus, the variable authorization segment of the message uses fields necessary only for the particular payment method used during that transaction. In like manner, the variable service payload segment uses fields of data that are necessary only to complete the particular transaction specified by the user. An optimal segment allows flexibility to deliver additional information if required for new modules added to the terminal device 5, or for trace/debugging data as the message moves through the network. The transaction message format between the user device 61 and the transaction server 72 is thus very flexible in order to accommodate an unlimited number of services and payment methods.

The basic transmission message format 200 utilized in connection with the preferred form of the invention is illustrated in FIG. 7a. A more detailed transmission message format 200, showing the various fields of each segment, is shown in FIG. 7b. The user device request and response messages 200 of FIG. 7a are formatted into three segments, including an a device or terminal information segment 202 which is termed “fixed” because many of the fields therein identify various parameters of the user device or terminal itself, which parameters do not change over time. For example, one field of the terminal information segment 202 identifies the serial number of the device. Other fields of the terminal information segment 202 identify other fixed parameters of the user device.

An authorization information variable segment 204 of the transaction message 200 identifies the necessary authorization information and allows a variable length payload area to accommodate an unlimited variety of payment methods. The authorization segment payload is formatted to the specific type of purchase method. Credit card transactions may carry card number and expiration date, while debit transactions may carry the card number and encrypted pin block.

The service payload segment 206 of the transaction message 200 includes a layout of information that is specific to the type of transaction being conducted at the at the user device 61. This segment 206 holds data specific to the product or service being purchased. Calling card transactions will carry units purchased, while a bill payment may carry utility company and account information.

The details of the format of the terminal information segment 202 are set forth below in Table 1. This table identifies the common terminal information required by the user devices 61 communicating with the transaction server 72. The number of fields in this segment 202 is fixed, and the data in various fields identifies the respective layouts of the authorization segment 204 and the service payload segment 206.

TABLE 1
Information Segment Layout

| Field Number | Field Name | Field Length | Field Type | Format | Description |
|---|---|---|---|---|---|
| 1 | HostRoutingID | 4 | AN | | Data Carrier host routing ID. |
| | | | | | A code identifying the host system |
| | | | | | to which the transaction will be |
| | | | | | routed. |
| 2 | TerminalID | 20 | AN | LJ | Terminal Identifier. |
| | | | | | A unique name assigned to the |
| | | | | | terminal at terminal setup. |
| 3 | TermSerNum | 20 | AN | | Terminal serial number. |
| | | | | | The serial number of the terminal. |
| 4 | TermSeqNum | 20, 0 | N | RJ ZF | Terminal sequence number. |
| | | | | | A sequential control number |
| | | | | | assigned by the terminal and used |
| | | | | | to identify each transaction. |
| 5 | TranSessNum | 12, 0 | N | RJ ZF | Transaction session number. |
| | | | | | A sequential control number |
| | | | | | assigned by the terminal and used |
| | | | | | to identify each Sign-on at the |
| | | | | | terminal. |
| 6 | InitRqsTimeStamp | 26 | TX | TimStmp | Initial request timestamp. |
| | | | | | The date and time which the |
| | | | | | transaction was initially requested. |
| | | | | | Format: Yyyy-mm-dd-hh.mm.ss. |
| | | | | | mmmmmmmmmm = microseconds. |
| 7 | ServID | 3 | AN | LJ | Unused |
| | UNUSED | | | | |
| | FIELD | | | | |
| 8 | PayEncMethod | 2 | AN | | Payload encryption method. |
| | | | | | A code identifying the method |
| | | | | | used for encryption of payload |
| | | | | | segment. |
| | | | | | See Table 2 for valid encryption |
| | | | | | methods. |
| 9 | AuthTypeCode | 4 | AN | | Authorization type ID. |
| | | | | | A code identifying the type of |
| | | | | | authorization being used. |
| | | | | | See Table 3 for valid authorization |
| | | | | | types. |
| 10 | AuthFmtcode | 4 | AN | | Authorization format ID. |
| | | | | | A code identifying the format of |
| | | | | | the authorization segment being |
| | | | | | used. |
| | | | | | See Table 3 for valid authorization |
| | | | | | formats. |
| 11 | AuthSegLen | 3, 0 | N | RJ ZF | Authorization segment length. |
| | | | | | The length of the authorization |
| | | | | | segment. |
| | | | | | Maximum size 300 bytes. |
| 12 | ServTypeCode | 4 | AN | | Service payload type ID. |
| | | | | | A code identifying the type of |
| | | | | | service payload being used. See |
| | | | | | Table 4 for valid service types. |
| 13 | ServFmtCode | 4 | AN | | Service payload format ID. |
| | | | | | A code identifying the format of |
| | | | | | the service payload segment being |
| | | | | | used. |
| | | | | | See Table 4 for valid service |
| | | | | | formats. |
| 14 | ServSegLen | 3, 0 | N | RJ ZF | Service payload segment length. |
| | | | | | The length of the service payload |
| | | | | | segment. |
| | | | | | Maximum size 500 bytes. |
| 15 | OptSegLen | 3, 0 | N | RJ ZF | Optional information segment |
| | | | | | length. |
| | | | | | The length of the information |
| | | | | | segment. |
| | | | | | Maximum size 500 bytes. |

(Size—132 bytes)

The terminal information segment 202 includes fifteen fields in the preferred form of the invention. The first field is of a four-byte length which carries in alphanumeric characters the host routing identification. This ID uniquely identifies the host system so that it can be easily accessed by the transaction server 72. The second field of the segment 202 carries a twenty-byte terminal identification number. This number uniquely identifies each user device or terminal 5. This field of data is justified with zero-filled spaces. Fields three and four carry respectively the terminal serial number and the terminal sequence number. The serial number is the number stamped on the serial number tag of the terminal 5. The terminal sequence number is a sequential control number assigned by the terminal 5 and used to identify each transaction of the terminal 5. This data can be used for purposes of tracking back to determine events that may have occurred during a specific prior transaction. Field five of the information segment 202 is a twelve-byte field that carries the terminal session number. This is a sequential control number that is assigned by the terminal and used to identify each sign-on at the terminal 5. Field six carries a twenty-six byte time stamp of the date and time a transaction was initially requested. Field seven is an unused field. Field eight is a two-byte field of data that carries a code which identifies the method used for encryption of the payload segment. Table 2 illustrates the various encryption methods that can be utilized, it being realized that other methods can also be employed.

TABLE 2
Encryption Methods

| Code | Encryption Type |
|---|---|
| 10 | DES |
| 20 | BLOW FISH |
| 30 | 2 FISH |
| 40 | RSA |

The ninth field of the terminal information segment 202 is a four-byte field that specifies the type of payment authorization being used. Table 3 below illustrates the various authorization formats for the payment methods. The layout of the fields of the authorization information segment are predefined to include data fields particular to ATM payments when this field of the terminal segment carries the code “0100”. The other codes noted in Table 3 illustrate the other methods of payment which, in turn, specify the particular layouts of the respective data fields of the authorization segment 204 when the respective codes are written into field nine of the terminal information segment 202. It should be noted that when the user of the kiosk terminal 5 touches a touch screen area to indicate a cash transaction is desired, the user kiosk terminal 5 will automatically write into field nine of the terminal information segment 202 the code “0400”. The authorization type code “0900” defines a reversal of the last transaction service requested. When used, the message will contain a response code only, and not a service payload segment. As can be appreciated, field nine of the terminal information segment 202 can accommodate many other methods of payment, as may be necessary to accommodate new payment methods as they arise.

TABLE 3
Authorization Formats

| Authorization Type | Description | Format Code |
|---|---|---|
| 0100 | Standard ATM Card | ATM1 |
| 0200 | Standard POS Debit Card | POS1 |
| 0300 | Credit Card | CRD1 |
| 0400 | Cash | CAS1 |
| 0500 | Standard Smart Card | SMT1 |
| 0600 | Check | CHK1 |
| 0900 | Reversal | REV1 |

Field ten of the information segment 202 carries a four-byte authorization format ID that identifies the format of the authorization segment being employed. Table 3 above illustrates the different authorization format codes. Field eleven is an authorization segment length that specifies different authorization segment 204 of the transmission message 200, the maximum of which is 300 bytes.

Field twelve of the terminal information segment 202 is a four-byte field which specifies the type of the service payload segment 206. This field can be write therein with a four digit code to specify the vendor involved in the financial transaction, as well as information concerning the goods/services which are the to be purchased or for which payment is to be made. Table 4 below illustrates the different service payload types.

TABLE 4

| Service Payload Type | Description | Format Code |
|---|---|---|
| 0050 | Get Host Totals | TOT1 |
| 0051 | Get Totals & Change Business Day | TOT1 |
| 0060 | Download Communications Key | KEY1 |
| 0090 | Currency Conversion Request | CUR1 |
| 0111 | Checking Withdrawal | SPA1 |
| 0112 | Savings Withdrawal | SPA1 |
| 0115 | Credit Cash Advance | SPA1 |
| 0121 | Transfer Checking to Savings | SPA1 |
| 0122 | Transfer Savings to Checking | SPA1 |
| 0125 | Transfer Credit to Checking | SPA1 |
| 0126 | Transfer Credit to Savings | SPA1 |
| 0131 | Checking Inquiry | SPA1 |
| 0132 | Savings Inquiry | SPA1 |
| 0135 | Credit Inquiry | SPA1 |
| 0211 | POS Transaction from Checking | POS1 |
| 0212 | POS Transaction from Savings | POS1 |
| 0215 | POS Transaction from Credit | POS1 |
| 0311 | Money Order Purchase | MOR1 |
| 0321 | Script Receipt | SCR1 |
| 0401 | Vendor ? Calling Card-10 minutes | CCA1 |
| 0402 | Vendor ? Calling Card-30 minutes | CCA1 |
| 0403 | Vendor ? Calling Card-60 minutes | CCA1 |
| 0501 | Cash Deposit to system | SPC1 |
| 0502 | Cash Withdrawal from system | SPC1 |
| 0601 | Cash Payment to on-line Vendor | ? |
| 0651 | Ticket Inquiry | TIK1 |
| 0652 | Ticket Payment | TIK2 |

Field thirteen of the terminal information segment 202 carries a four-byte code that specifies the service payload format ID. Table 4 illustrates the various format codes corresponding to the different formats of the service payload used by the kiosk terminal 5 in response to a choice by the user as input to the touch screen 20. Field fourteen is a three-byte field that specifies the length of the service payload segment 206 which has a maximum length of 500 bytes. Field fifteen is a three byte field that specifies the length of an optional information segment, which has a maximum length of 500 bytes. The overall size of the terminal information segment 202 is 132 bytes in the preferred form of the invention. As needs for other types of parameters arise, the size of the segment 202 may be different from that described above.

The authorization segment 204 of the transaction message 200 is appended to the information segment 202 and contains the information necessary to complete a transaction, based on a specific method of payment. Field nine (Table 1) of the terminal information segment 202 segment defines the different formats to accommodate a variety of payment methods such as debit, credit, cash, smart card and other methods. The authorization payment type code of field nine is separated into two sections. The first two digits determine the type of payment, and the second two digits detail the manner in which the information is formatted.

As noted above, the layout and style of the authorization information segment 204 of the transaction message 200 is determined by the code written in byte nine of the terminal information segment 202. Thus, the authorization information segment 204 is described in terms of the various codes that define the different methods of payments that are used by the banked and unbanked financial network. An advantage to this type of message is that as new methods of payment are developed, the basic nature of the message format need not be changed. The only change would be a new code for the new method of payment, and the corresponding layout of the authorization information segment having fields that are necessary to describe and carry out such type of payment.

If the user inputs to the device 5 (or terminal) via the touch screen an indication that payment is to be made by way of an ATM (Table 3), then the device 5 will automatically insert the code “0100” in field nine of the terminal information segment 202. The ATM segment layout of authorization code “0100” is illustrated below in Table 5. The device 5 will then solicit from the user thereof the information that is necessary for writing into the various fields of the authorization information segment 204. Field one of segment 204 is a twelve-byte data field carrying the dollar amount of the transaction, right justified with zero-filled blank spaces. A decimal is implied between the second and third digits from the right of the number. The field is numeric, as noted in Table 5.

Field two of the ATM authorization segment is also twelve-bytes in length for holding data defining the surcharge or service charge for carrying out the unbanked transaction. Field three carries the amount of funds dispensed by the ATM terminal, and field four is a sixteen-byte field carrying the PIN block information which is the encrypted PIN input to the kiosk terminal 5 by the user. Field six of the ATM authorization information segment is an eighty-byte field describing the track 2 data read from the credit or debit card and carries the response codes from the banked financial network 51 concerning the transaction codes written in this field indicate whether the transaction was accepted or rejected.

TABLE 5
Standard ATM Authorizations

| Field | Field | Field | Field | | |
|---|---|---|---|---|---|
| Number | Name | Length | Type | Format | Description |
| 1 | TranAmt | 12, 3 | N | RJ ZF | Amount of transaction. |
| | | | | | This is the requested |
| | | | | | amount of the |
| | | | | | transaction. |
| 2 | SurChgAmt | 12, 3 | N | RJ ZF | Amount of surcharge. |
| | | | | | This is the total fees |
| | | | | | and surcharges for the |
| | | | | | transaction. |
| 3 | DispAmt | 12, 3 | N | RJ ZF | Dispensed amount. |
| | | | | | This is the actual |
| | | | | | amount dispensed by |
| | | | | | the ATM terminal. |
| 4 | PIN Block | 16 | AN | | Encrypted PIN |
| | | | | | number. |
| | | | | | This is the encrypted |
| | | | | | PIN block. |
| 5 | RespCode | 3 | AN | | Response code. |
| | | | | | A code used to |
| | | | | | identify the reason |
| | | | | | the transaction was |
| | | | | | either accepted or |
| | | | | | denied. |
| | | | | | See Table 6 for valid |
| | | | | | response codes. |
| 6 | Trk2Data | 80 | AN | | Track 2 data. |
| | | | | | Actual Track 2 data |
| | | | | | from credit or |
| | | | | | debit card. |

Table 6 illustrates the various response codes as a function of an ATM transaction. The response codes are used when an attempted ATM transaction cannot be completed, and such responses are returned to the kiosk terminal or device 5.

TABLE 6
Authorization Type 0100

| ATM Transaction Response Codes | |
|---|---|
| A00-Approved | D08-Ineligible Transaction |
| D01-Expired Card | D09-Ineligible Account |
| D02-Unauthorized Usage | D10-No Further Withdrawals |
| D03-PIN Error | D11-Cannot Process |
| D04-Incorrect PIN | D12-Try Lessor Amount |
| D05-Bank Unavailable | D13-Closed Account |
| D06-Card Unsupported | D29-Reversal Declined |
| D07-Insufficient Funds | D99-Declined, Unspecified |

If the user of the MFC terminal 5 inputs thereto an indication that the method of payment is to be by way of a debit card, then the kiosk terminal 5 automatically inserts in field nine of the terminal information segment 202 the code for “POS Debit” (point of sale debit), namely the code “0200” (Table 3). The corresponding POS Debit authorization information segment is shown in Table 7 below.

TABLE 7
Standard POS Debit Authorizations

| Field | | Field | Field | | |
|---|---|---|---|---|---|
| Number | Field Name | Length | Type | Format | Description |
| 1 | TranAmt | 12, 3 | N | RJ ZF | Amount of |
| | | | | | transaction. |
| | | | | | This is the |
| | | | | | requested amount |
| | | | | | of the transaction. |
| 2 | SurChgAmt | 12, 3 | N | RJ ZF | Amount of |
| | | | | | surcharge. |
| | | | | | This is the total |
| | | | | | fees and |
| | | | | | surcharges for |
| | | | | | this transaction. |
| 3 | PINBlk | 16 | AN | | Encrypted PIN |
| | | | | | number. |
| | | | | | This is the |
| | | | | | encrypted PIN |
| | | | | | block. |
| 4 | WhoID | 2 | AN | | A code |
| | | | | | identifying who |
| | | | | | swiped the card. |
| 5 | ExpDate | 8 | N | yyyymmdd | Expiration date. |
| 6 | RespCode | 3 | AN | | Response code. |
| | | | | | A code used to |
| | | | | | identify the |
| | | | | | reason the |
| | | | | | transaction was |
| | | | | | either accepted or |
| | | | | | denied. |
| | | | | | See Table 8 for |
| | | | | | valid response |
| | | | | | codes. |
| 7 | Trk2Data | 80 | AN | | Track 2 data. |
| | | | | | Actual Track 2 |
| | | | | | data from credit |
| | | | | | or debit card. |

The corresponding POS debit transaction response codes are set forth below in Table 8.

TABLE 8

| POS Debit Transaction Response Code | Authorization Type 0200 |
|---|---|
| A00-Approved | D08-Ineligible Transaction |
| D01-Expired Card | D09-Ineligible Account |
| D02-Unauthorized Usage | 010-No Further Withdrawals |
| D03-PIN Error | D11-Cannot Process |
| D04-Incorrect PIN | D12-Try Lessor Amount |
| D05-Bank Unavailable | D13-Closed Account |
| D06-Card Unsupported | D29-Reversal Declined |
| D07-Insufficient Funds | D99-Declined, unspecified |

The response codes for credit card transactions is shown in Table 9; the response codes for cash transactions are shown in Table 10; the response codes for Smart card transactions are shown in Table 11; and the response codes for check transactions are shown in Table 12. The authorization information segments corresponding to these response codes are described below.

TABLE 9
Credit Card Transaction Response Codes-Authorization Type 0300

| | |
|---|---|
| A00-Approved | D08-Ineligible Transaction |
| D01-Expired Card | D09-Ineligible Account |
| D02-Unauthorized Usage | D11-Cannot Process |
| D03-Over Credit Limit | D13-Closed Account |
| D05-Bank Unavailable | D29-Reversal Declined |
| D06-Card Unsupported | D99-Declined, unspecified |

TABLE 10
Cash Transaction Response Codes-Authorization Type 0400

| | |
|---|---|
| A00-Approved | D99-Declined, unspecified |

TABLE 11
Smart Card Transaction Response Codes-Authorization Type 0500

| | |
|---|---|
| A00-Approved | D99-Declined, unspecified |

TABLE 12
Check Transaction Response Codes-Authorization Type 0600

| | |
|---|---|
| A00-Approved | D99-Declined, unspecified |

When the user of a kiosk terminal 5 inputs an indication that the method of payment is to be by way of a credit card, there is automatically inserted in field nine of the terminal information segment 202 the code for credit card payments, namely code “0300” (Table 3). The format of the corresponding credit card authorization information segment is shown in Table 13.

TABLE 13
Standard Credit Authorizations

| Field | | Field | Field | | |
|---|---|---|---|---|---|
| Number | Field Name | Length | Type | Format | Description |
| 1 | TranAmt | 12, 3 | N | RJ ZF | Amount of |
| | | | | | transaction. |
| | | | | | This is the |
| | | | | | requested amount |
| | | | | | of the transaction. |
| 2 | SurChgAmt | 12, 3 | N | RJ ZF | Amount of |
| | | | | | surcharge. |
| | | | | | This is the total |
| | | | | | fees and |
| | | | | | surcharges for |
| | | | | | this transaction. |
| 3 | PINBlk | 16 | AN | | Encrypted PIN |
| | | | | | number. |
| | | | | | This is the |
| | | | | | encrypted PIN |
| | | | | | block. |
| 4 | WhoID | 2 | AN | | A code |
| | | | | | identifying who |
| | | | | | swiped the card. |
| 5 | ExpDate | 8 | N | yyyymmdd | Expiration date. |
| | | | | | Expiration date |
| | | | | | on the credit or |
| | | | | | debit card. |
| | | | | | Format: |
| | | | | | YYYYMMDD |
| 6 | RespCode | 3 | AN | | Response code. |
| | | | | | A code used to |
| | | | | | identify the |
| | | | | | reason the |
| | | | | | transaction was |
| | | | | | either accepted or |
| | | | | | denied. |
| | | | | | See Table 9 for |
| | | | | | valid response |
| | | | | | codes. |
| 7 | Trk2Data | 80 | AN | | Track 2 data. |
| | | | | | Actual Track 2 |
| | | | | | data from credit |
| | | | | | or debit card. |

In the event that the user of the kiosk terminal 5 indicates that the method of payment for the transaction is to be cash, then the device automatically inserts in field nine of the terminal information segment 202 the code for cash, namely code “0400” (Table 3). The corresponding cash authorization information segment is shown below in Table 14.

TABLE 14
Standard Cash Authorizations

| Field Number | Field Name | Field Length | Field Type | Format | Description |
|---|---|---|---|---|---|
| 1 | BegBalance | 12, 3 | N | RJ ZF | Beginning cash balance. |
| | | | | | The balance prior to this |
| | | | | | transaction for current |
| | | | | | customer's session. |
| 2 | CurFunds | 12, 3 | N | RJ ZF | Current funds. |
| | | | | | Amount of this transaction. |
| 3 | EndBalance | 12, 3 | N | RJ ZF | Ending cash balance. |
| | | | | | The balance after this |
| | | | | | transaction for current |
| | | | | | customer's session. |
| 4 | CurrCode | 3 | AN | | Currency code. |
| | | | | | “840”—USA |
| 5 | RespCode | 3 | AN | | Response code. |
| | | | | | A code used to identify the |
| | | | | | reason the transaction was |
| | | | | | either accepted or denied. |
| | | | | | See Table 10 for valid |
| | | | | | response codes. |
| 6 | CashUserID | 64 (10) | AN | | User name. |
| | | | | | A 10 character user name |
| | | | | | entered at terminal by |
| | | | | | customer. |
| | | | | | (Encrypted to 64 bytes) |
| 7 | CashPwd | 64 (10) | AN | | User password. |
| | | | | | A 10 character user |
| | | | | | password entered at |
| | | | | | terminal by customer. |
| | | | | | (Encrypted to 64 bytes) |
| 8 | CashAuthNum | 64 (8) | N | RJ ZF | Cash authorization number. |
| | | | | | An 8 character tracking |
| | | | | | number assigned by system |
| | | | | | identifying this transaction. |
| | | | | | (Encrypted to 64 bytes) |

Size—234 bytes

If the method of payment is selected by the user to be a smart card transaction, the terminal will automatically insert in the terminal information segment 202 the code for a smart card transaction, namely code “0500”. The corresponding credit and authorization information segment is shown below in Table 15.

TABLE 15
Standard Cash Authorizations

| Field | Field | Field | Field | | |
|---|---|---|---|---|---|
| Number | Name | Length | Type | Format | Description |
| 1 | RespCode | 3 | AN | | Response code. |
| | | | | | A code used to identify |
| | | | | | the reason the transaction |
| | | | | | was either accepted or |
| | | | | | denied. |
| | | | | | See Table 11 for valid |
| | | | | | response codes. |

In the event the method of payment is selected by the user to be a check transaction, the terminal 5 will automatically insert in the terminal information segment 202 the code for a check transaction, namely code “0600”. The corresponding check authorization information segment is shown below in Table 16.

TABLE 16
Standard Check Authorizations

| Field | | Field | Field | | |
|---|---|---|---|---|---|
| Number | Field Name | Length | Type | Format | Description |
| 1 | TranAmt | 12, 3 | N | RJ ZF | Amount of |
| | | | | | transaction. |
| | | | | | This is the requested |
| | | | | | amount of the |
| | | | | | transaction. |
| 2 | SurChgAmt | 12, 3 | N | RJ ZF | Amount of |
| | | | | | surcharge. |
| | | | | | This is the total fees |
| | | | | | and surcharges for |
| | | | | | this transaction. |
| 3 | CurrCode | 3 | AN | RJ ZF | Encrypted PIN |
| | | | | | number. |
| | | | | | This is the |
| | | | | | encrypted PIN |
| | | | | | block. |
| 4 | RespCode | 3 | AN | | Response Code. |
| | | | | | A code used to |
| | | | | | identify the reason |
| | | | | | the transaction was |
| | | | | | either accepted or |
| | | | | | denied. |
| | | | | | See Table 12 for |
| | | | | | valid response |
| | | | | | codes. |
| 5 | ChkNum | 5 | N | RJ ZF | Check Number. |
| | | | | | A check number |
| | | | | | assigned by the |
| | | | | | system. |
| 6 | BankRtgNum | 12 | AN | | Bank routing |
| | | | | | number. |
| | | | | | Bank ABA routing |
| | | | | | number. |
| 7 | BankAccNum | 20 | AN | | Bank account |
| | | | | | number. |
| | | | | | Bank account |
| | | | | | number. |

The authorization format “Rev1 ” for a standard reversal is shown below in Table 17.

TABLE 17
Standard Reversals

| Field | Field | Field | Field | | |
|---|---|---|---|---|---|
| Number | Name | Length | Type | Format | Description |
| 1 | RespCode | 3 | AN | | Response code. |
| | | | | | A code used to identify |
| | | | | | the reason the transaction |
| | | | | | was either accepted or |
| | | | | | denied. |

There is a corresponding authorization information segment layout for each of the methods of payment. Each such layout has the fields necessary to allow communication of information throughout the unbanked network 62 as well as the banked network 51.

The various types of service payloads and formats are shown above in Table 4. The details of the various service payload formats are illustrated below.

The layout of the service payload segment 206 for an ATM transaction is illustrated below in Table 18. When the user of the kiosk terminal 5 indicates that the ATM transaction is for the various services available, a corresponding code is inserted into field thirteen of the terminal information segment 202. The layout of the service payload segment 206 varies for each service provided by the transaction server 72. This segment 206 of the transaction message 200 is variable in layout, and can thus be characterized to accommodate new services as they arise.

TABLE 18
Service Payload Format “SPA1”—Standard ATM Transactions

| Field Number | Field Name | Field Length | Field Type | Format | Description |
|---|---|---|---|---|---|
| 1 | NetAuthNum | 20 | AN | | Financial network |
| | | | | | authorization number |
| | | | | | The authorization number |
| | | | | | from the financial network. |
| 2 | NetDate | 8 | N | yyyymmdd | Date from financial network |
| | | | | | Processing date received |
| | | | | | from the financial network |
| | | | | | at time of authorization. |
| | | | | | Format: YYYYMMDD |
| 3 | NetTime | 6 | N | hhmmss | Time from financial |
| | | | | | network. Processing time |
| | | | | | received from the financial |
| | | | | | network at time of authorization. |
| | | | | | Format: HHMMSS |
| 4 | NetBusDate | 8 | N | yyyymmdd | Business date from financial network. |
| | | | | | Business date received from |
| | | | | | the financial network at time of authorization. |
| | | | | | Format: YYYYMMDD |
| 5 | AccBal1 | 12, 3 | N | RJ ZF | Account balance 1. |
| | | | | | This field contains the |
| | | | | | current balance on a balance |
| | | | | | inquiry transaction. |
| 6 | AccBal2 | 12, 3 | N | RJ ZF | Account balance 2. |
| | | | | | This field contains the |
| | | | | | authorized amount on other |
| | | | | | types of transactions. |

The response code corresponding to the ATM service payload is shown below in Table 19.

TABLE 19
Standard ATM Transactions-Service Payload Format-SPA1

| | |
|---|---|
| A00-Approved | D08-Ineligible Transaction |
| D01-Expired Card | D09-Ineligible Account |
| D02-Unauthorized Usage | D10-No Further Withdrawals |
| D03-PIN Error | D11-Cannot Process |
| D04-Incorrect PIN | D12-Try Lessor Amount |
| D05-Bank Unavailable | D13-Closed Account |
| D06-Card Unsupported | D29-Reversal Declined |
| D07-Insufficient Funds | D99-Declined, unspecified |

The response code corresponding to a cash transaction service payload is shown below in Table 20.

TABLE 20
Standard Cash Transactions - Service Payload Format - CAS 1

| | |
|---|---|
| A00 - Approved | D99 - Declined, unspecified |

The response code corresponding to a currency conversion request service payload is shown below in Table 21; the response code for a download communication key service payload is shown in Table 22; the response code for a download host totals service payload is shown in Table 23; the response code for a money order purchase service payload is shown in Table 24; the response code for a calling card purchase service payload is shown in Table 25; and the response code for a print scrip receipt request service payload is set forth in Table 26.

TABLE 21
Currency Conversion Request - Service Payload Format - CUR1
None defined.

TABLE 22
Download Communcations Key - Service Payload Format - KEY1
None defined.

TABLE 23
Download Host Totals - Service Payload Format - TOT1
None defined.

TABLE 24
Money Order Purchases - Service Payload Format - MOR1

| | |
|---|---|
| A00 - Approved | D99 - Declined, unspecified |

TABLE 25
Calling Card Purchases - Service Payload Format - CCA1

| | |
|---|---|
| A00 - Approved | D99 - Declined, unspecified |

TABLE 26
Print Scrip Receipt Request - Service Payload Format - SCR1
None defined.

The service payload format for a cash transaction is set forth below in Table 27. The description of the various fields is set forth in the table.

TABLE 27
Service Payload Format “SPC1”—Standard Cash Transactions

| Field Number | Field Name | Field Length | Field Type | Format | Description |
|---|---|---|---|---|---|
| 1 | CasiAudNum | 30 | AN | | Terminal audit number. |
| | | | | | A tracking number generated by the |
| | | | | | system identifying this transaction. |
| 2 | CasiDate | 8 | N | yyyymmdd | Terminal date. |
| | | | | | Processing date of this transaction. |
| | | | | | Format: YYYYMMDD |
| 3 | CasiTime | 6 | N | hhmmss | Terminal time. |
| | | | | | Processing time of this transaction. |
| | | | | | Format: HHMMSS |
| 4 | CasiRespCode | 3 | AN | | Terminal response code. |
| | | | | | A code used to identify the |
| | | | | | reason the transaction was |
| | | | | | either accepted or denied. |
| | | | | | See Table 20 for valid response codes. |
| 5 | CasiAccBal | 12, 3 | N | | Account balance. |
| | | | | | Current balance on this |
| | | | | | Terminal account. |

The service payload format for a currency conversion request is shown below in Table 28. The description of the various fields is set forth in the table.

TABLE 28
Service Payload Format “CUR1” - Currency Conversion Request

| Field | | Field | Field | | |
|---|---|---|---|---|---|
| Number | Field Name | Length | Type | Format | Description |
| 1 | FromCurrCode | 3 | AN | | From currency code. |
| | | | | | A code identifying the |
| | | | | | currency to convert from. |
| 2 | ToCurrCode | 3 | AN | | To currency code. |
| | | | | | A code identifying the |
| | | | | | currency to convert to. |
| 3 | ConvRate | 12.6 | N | nnnnnn.nnnnnn | Conversion rate. |
| | | | | | The current currency |
| | | | | | conversion rate. |
| 4 | ConvFact | 12.6 | N | nnnnnn.nnnnnn | Conversion factor. |
| | | | | | The current currency |
| | | | | | conversion factor. |
| 5 | ConvDate | 8 | N | yyyymmdd | Conversion date. |
| | | | | | The processing date at the |
| | | | | | time of this currency |
| | | | | | conversion. |
| | | | | | Format: YYYYMMDD |
| 6 | ConvTime | 6 | N | hhmmss | Conversion time. |
| | | | | | The precessing time at the |
| | | | | | time of this currency |
| | | | | | conversion. |
| | | | | | Format: HHMMSS |
| 7 | ConvRespCode | 3 | AN | | Response code. |
| | | | | | A code used to identify the |
| | | | | | reason the transaction was |
| | | | | | either accepted or denied. |
| | | | | | See Table 21 for valid |
| | | | | | response code. |

The service payload format for a communications key request is shown below in Table 29. The description of the various fields is set forth in the table.

TABLE 29
Service Payload Format “KEY” - Download Communication Key Request

| Field | | Field | Field | | |
|---|---|---|---|---|---|
| Number | Field Name | Length | Type | Format | Description |
| 1 | EncCommKey | 64 | AN | | Encrypted communications |
| | | | | | key. |
| | | | | | This field contains the |
| | | | | | encrypted communications |
| | | | | | key for the terminal. |
| 2 | SurChgAmt | 12.3 | N | RJ ZF | Surcharge amount. |
| | | | | | Amount of fees and |
| | | | | | surcharges to be charged at |
| | | | | | this terminal. |
| 3 | RespCode | 3 | AN | | Response Code. A code to |
| | | | | | identify the reason the |
| | | | | | transaction was either |
| | | | | | accepted or denied. |
| | | | | | See Table 22 for valid |
| | | | | | response codes. |

The service payload format for a host total download request is shown below in Table 30. The description of the various fields is set forth in the table.

TABLE 30
Service Payload Format “TOT1” - Download Host Totals Request

| Field | | Field | Field | | |
|---|---|---|---|---|---|
| Number | Field Name | Length | Type | Format | Description |
| 1 | BusDate | 8 | N | yyyymmdd | Business Date. |
| | | | | | The business processing |
| | | | | | date for this terminal. |
| | | | | | Format: YYYYMMDD |
| 2 | NbrWith | 12.0 | N | RJ ZF | Number of withdrawals. |
| | | | | | This field contains the |
| | | | | | number of withdrawals for |
| | | | | | this terminal since the last |
| | | | | | download totals request. |
| 3 | NbrInq | 12.0 | N | RJ ZF | Number of inquiries. |
| | | | | | This field contains the total |
| | | | | | number of inquiries for this |
| | | | | | terminal since the last |
| | | | | | download totals request. |
| 4 | NbrTrn | 12.0 | N | RJ ZF | Number of transactions. |
| | | | | | This field contains the total |
| | | | | | number of transactions for |
| | | | | | this terminal since the last |
| | | | | | download totals request. |
| 5 | With$ | 12.3 | N | RJ ZF | Dollars withdrawn. |
| | | | | | This field contains the total |
| | | | | | amount of withdrawals for |
| | | | | | terminal since the last |
| | | | | | download totals request. |
| 6 | Tran$ | 12.3 | N | RJ ZF | Dollars transferred. |
| | | | | | This field contains the total |
| | | | | | amount of transfers for this |
| | | | | | terminal since the last |
| | | | | | download totals request. |
| 7 | Prepaid$ | 12.3 | N | RJ ZF | Prepaid service dollars. |
| | | | | | This field contains the total |
| | | | | | amount of prepaid services |
| | | | | | sold for this terminal since |
| | | | | | the last download totals |
| | | | | | request. |
| 8 | Scrip$ | 12.3 | N | RJ ZF | Scrip dollars. |
| | | | | | This field contains the total |
| | | | | | amount of scrip receipts |
| | | | | | written for this terminal |
| | | | | | since the last download |
| | | | | | totals request. |
| 9 | MO$ | 12.3 | N | RJ ZF | Money order dollars. |
| | | | | | This field contains the total |
| | | | | | amount of money orders |
| | | | | | issued for this terminal |
| | | | | | since the last download |
| | | | | | totals request. |
| 10 | Cash$ | 12.3 | N | RJ ZF | Cash deposited into ATM. |
| | | | | | This field contains the total |
| | | | | | amount of cash deposited |
| | | | | | into this terminal since the |
| | | | | | last download totals |
| | | | | | request. |
| 11 | RespCode | 3 | AN | | Response Code. |
| | | | | | A code used to identify the |
| | | | | | reason the transaction was |
| | | | | | either accepted or denied. |
| | | | | | See Table 23 for valid |
| | | | | | response codes. |

The service payload format for a money order purchase is shown below in Table 31. The description of the various fields is set forth in the table.

TABLE 31
Service Payload Format “MOR1” - Money Order Purchase

| Field | | Field | Field | | |
|---|---|---|---|---|---|
| Number | Field Name | Length | Type | Format | Description |
| 1 | SrvNetID | 30 | AN | | Service provider network |
| | | | | | ID. Network identifier |
| | | | | | for the issuer of |
| | | | | | money orders. |
| 2 | MOCheck# | 16 | AN | | Money order check #. |
| | | | | | An internally generated |
| | | | | | unique check number that |
| | | | | | will be assigned to this |
| | | | | | money order. |
| 3 | MOPayTo | 40 | AN | | Payable to. |
| | | | | | This is the person payable |
| | | | | | to printed on the money |
| | | | | | order. |
| 4 | MOAmt | 12.3 | N | RJ ZF | Money order amount. |
| | | | | | The amount of this money |
| | | | | | order. |
| 5 | MOABA# | 30 | AN | | Bank account ABA #. |
| | | | | | Bank ABA routing number. |
| 6 | MOAcct# | 30 | AN | | Bank account #. |
| | | | | | Bank account number. |
| 7 | MOTrans# | 16 | AN | | Transaction #. |
| | | | | | A unique tracking number |
| | | | | | assigned to this money |
| | | | | | order transaction. |
| 8 | RespCode | 3 | AN | | Response code. |
| | | | | | A code used to identify the |
| | | | | | reason the transaction was |
| | | | | | either accepted or denied. |
| | | | | | See Table 24 for valid |
| | | | | | response codes. |

The service payload format for a calling card purchase is shown below in Table 32. The description of the various fields is set forth in the table.

TABLE 32
Service Payload Format “CCA1” - Calling Card Purchase

| Field | | Field | Field | | |
|---|---|---|---|---|---|
| Number | Field Name | Length | Type | Format | Description |
| 1 | SrvNetID | 30 | AN | | Service provider network |
| | | | | | ID. |
| | | | | | Network identifier of the |
| | | | | | calling card service |
| | | | | | provider. |
| 2 | CCTel# | 15 | AN | | Telephone # for service. |
| | | | | | Access number to be |
| | | | | | printed on receipt for |
| | | | | | calling card service. |
| 3 | CCPIN# | 16 | AN | | PIN ID. |
| | | | | | Unique PIN number printed |
| | | | | | on receipt to access service. |
| 4 | CCAmt | 12.3 | N | RJ ZF | Purchase amount. |
| | | | | | Total purchase amount of |
| | | | | | this card. |
| 5 | CCTrans# | 16 | AN | | Transaction #. |
| | | | | | Unique tracking number |
| | | | | | assigned to this transaction. |
| 6 | RespCode | 3 | AN | | Response code. |
| | | | | | A code used to identify the |
| | | | | | reason the transaction was |
| | | | | | either accepted or denied. |
| | | | | | See Table 25 for valid |
| | | | | | response codes. |

The service payload format for a scrip receipt request is shown below in Table 33. The description of the various fields is set forth in the table.

TABLE 33
Service Payload Format “SCR1” - Scrip Receipt Request

| Field | | Field | Field | | |
|---|---|---|---|---|---|
| Number | Field Name | Length | Type | Format | Description |
| 1 | ScrAuth# | 16 | AN | | Authorization #. |
| | | | | | Unique tracking number |
| | | | | | assigned to this printed |
| | | | | | scrip. |
| 2 | ScrAmt | 12.3 | N | RJ ZF | Script amount. |
| | | | | | Amount of scrip. |
| 3 | RespCode | 3 | AN | | Response code. |
| | | | | | A code used to identify the |
| | | | | | reason the transaction was |
| | | | | | either accepted or denied. |
| | | | | | See Table 26 for valid |
| | | | | | response codes. |

The service payload format for a ticket inquiry request is shown below in Table 34. The description of the various fields is set forth in the table.

TABLE 34
Service Payload Format “TIKI1” - Ticket Inquiry

| Field | | Field | Field | | |
|---|---|---|---|---|---|
| Number | Field Name | Length | Type | Format | Description |
| 1 | Case# | 16 | AN | | Case number. |
| | | | | | Court case number |
| 2 | Ticket# | 16 | AN | | Ticket #. |
| | | | | | Unique ticket number. |
| 3 | VioDesc | 40 | AN | | Violation description |
| | | | | | Description of violation. |
| 4 | OffDate | 8 | N | yyyymmdd | Offense date. |
| | | | | | Date on which offense |
| | | | | | occurred. |
| 5 | DueDate | 8 | N | yyyymmdd | Due date. |
| | | | | | Date on which payment is |
| | | | | | due. |
| 6 | AmtDue | 12.3 | N | RJ ZF | Amount due. |
| | | | | | Amount due on ticket. |
| 7 | Status | 15 | AN | | Status. |
| | | | | | Current status of ticket. |
| 8 | Name | 40 | AN | | Name. |
| | | | | | Name on ticket. |
| 9 | Address | 40 | AN | | Address. |
| | | | | | Address on ticket. |
| 10 | City | 20 | AN | | City. |
| | | | | | City on ticket. |
| 11 | State | 2 | AN | | State. |
| | | | | | State on ticket. |
| 12 | Zip | 10 | AN | | Zip. |
| | | | | | Zip code on ticket. |
| 13 | LicPlate | 10 | AN | | License Plate #. |
| | | | | | License plate of vehicle |
| | | | | | involved in offense. |
| 14 | LicPlateSt | 2 | AN | | License plate state. |
| | | | | | State where license plate |
| | | | | | was issued. |
| 15 | CarYear | 4 | N | yyyy | Year of car. |
| | | | | | Year in which vehicle was |
| | | | | | manufactured. |
| 16 | CarMake | 20 | AN | | Make of car. |
| | | | | | Model/Make of vehicle |
| | | | | | involved in offense. |
| 17 | CarColor | 10 | AN | | Color of car. |
| | | | | | Color of vehicle involved in |
| | | | | | offense. |
| 18 | DrvLic | 10 | AN | | Driver license #. |
| | | | | | Drivers license # of person |
| | | | | | to whom ticket was issued. |
| 19 | DrvLicSt | 2 | AN | | Driver license state. |
| | | | | | State where drivers license |
| | | | | | was issued. |
| 20 | BirthDate | 8 | N | yyyymmdd | Birth date. |
| | | | | | Birth date of person to |
| | | | | | whom ticket was issued. |
| 21 | CurListNbr | 3.0 | N | RJ ZF | Current number (x of ...). |
| | | | | | A sequential number |
| | | | | | assigned to each response |
| | | | | | of the inquiry. |
| 22 | TotListNbr | 3.0 | N | RJ ZF | Total number (... of x). |
| | | | | | Total number of responses |
| | | | | | for the inquiry request. |
| 23 | RespCode | 3 | AN | | Response code. |
| | | | | | A code used to identify the |
| | | | | | reason the transaction was |
| | | | | | either accepted or denied. |

The service payload format for a ticket payment request is shown below in Table 35. The description of the various fields is set forth in the table.

TABLE 35
Service Payload Format “TIK2” - Ticket Payment

| Field | | Field | Field | | |
|---|---|---|---|---|---|
| Number | Field Name | Length | Type | Format | Description |
| 1 | Case# | 16 | AN | | Case number. |
| | | | | | Court case number. |
| 2 | Ticket# | 16 | AN | | Ticket #. |
| | | | | | Unique ticket number. |
| 3 | VioDesc | 40 | AN | | Violation description. |
| | | | | | Description of violation. |
| 4 | OffDate | 8 | N | yyyymmdd | Offense date. |
| | | | | | Date on which offense |
| | | | | | occurred. |
| 5 | DueDate | 8 | N | yyyymmdd | Due date. |
| | | | | | Date on which payment is |
| | | | | | due. |
| 6 | AmtDue | 12 | N | RJ ZF | Amount due. |
| | | | | | Amount due on ticket. |
| 7 | PmtAmt | 12 | N | RJ ZF | Payment amount. |
| | | | | | Amount paid. |
| 8 | RespCode | 3 | AN | | Response code. |
| | | | | | A code used to identify the |
| | | | | | reason the transaction was |
| | | | | | either accepted or denied. |
| 9 | TransNbr | 16 | AN | | Transaction number. |
| | | | | | A unique tracking number |
| | | | | | used to identify this |
| | | | | | transaction. |

Transmission messages 208 routed through the transaction server 72 are formatted in five segments, as shown in FIG. 7c. Each segment carries request and response data for it's particular part of the process. All segments allow variable lengths of information to provide scalability for subsequent enhancements. The different segments are described below.

Inter-process Segment 710—This segment identifies the entire message layout and is used to control routing through all modules within the transaction server system 72.

Terminal Information Segment 712—This segment identifies terminal information that is common for all terminals delivering transactions to the system.

Authorization Segment 714—This segment identifies the authorization information and allows a flexible length payload area to accommodate an unlimited variety of payment methods. The authorization segment payload is formatted to the specific type purchase method.

Service Payload Segment 716—The layout of information in this segment is specific to the type of transaction being conducted at the kiosk terminal. This segment holds data specific to the product or service being purchased.

Optional Segment 718—This segment of the message allows flexibility to deliver additional information if required for new transaction server modules or as trace/debugging data that becomes concatenated as the message moves through the system.

As noted in FIG. 7c, the entire message 208 is divided into five segments, some with fixed header information and some with variable length payload data. This provides the greatest amount of flexibility for enhancements.

The following describes the message formatting during a transaction sequence. The transaction router 41 receives a request transaction. It is the responsibility of the transaction router 41 to route the transaction to the proper enhanced service processor 26 based on information in the terminal information segment 712. The selected enhanced service processor 26 accepts the message 208 and encapsulates the three segments into the transaction server message 208. All other modules within the transaction server system use the message layout 208 to communicate with each other. It is the responsibility of the enhanced service processor 26 to communicate to the vendor systems according to the specifications defined by the parties. After the authorization and purchase is completed, the enhanced service processor 26 responds to the kiosk terminal 5 with the same three segments originally received. Information within those three segments dictate the actions of the kiosk terminal 5 (dispense, print, reverse, etc).

The inter-process segment 710 identifies the entire message layout and is used to control routing through all modules within the transaction router system. The various fields of the inter-process segment layout are shown in Table 36 below.

TABLE 36

| Field | | Field | Field | | |
|---|---|---|---|---|---|
| Number | Field Name | Length | Type | Format | Description |
| 1 | EtsID | 4 | AN | AANN | ID of the Acquiring ETC |
| 2 | TranTraceNum | 8 | N | RJ | Transaction sequence |
| | | | | | number |
| 3 | IPSegLength | 4 | N | | Inter-process Segment |
| | | | | | Length |
| 4 | TISegLength | 4 | N | | Terminal Information |
| | | | | | Segment Length |
| 5 | AISegLength | 4 | N | | Authorization Information |
| | | | | | Segment Length |
| 6 | SPSegLength | 4 | N | | Service Payload Segment |
| | | | | | Length |
| 7 | OISegLength | 4 | N | | Optional Information |
| | | | | | Segment Length |
| 8 | TransRouterID | 4 | AN | AANN | Alpha for Router Type, |
| | | | | | Numeric for instance |
| | | | | | number |
| 9 | DataCarrierTrace | 20 | AN | | Trace info for |
| | | | | | routing responses back |
| | | | | | to the terminal |
| 10 | ESPID | 5 | AN | AAANN | Alpha for EDP |
| | | | | | identification, Numeric |
| | | | | | for instance |
| | | | | | identifier |
| 11 | AuthProcID | 5 | AN | AAANN | Alpha for Auth processor |
| | | | | | identification, Numeric for |
| | | | | | instance identifier |

Collection of NSF Checks

In accordance with another feature of the invention, unpaid and uncollected checks due to insufficient funds can be redeemed without resort to collection agencies or the court system. The payor of the uncollected check has an opportunity to redeem the check in a private environment so that the public records do not reflect negatively on his/her credit. In essence, the payor of a check returned because of insufficient funds can use a kiosk terminal 5 and input therein the relevant information, including an identification number supplied by the payee, and provide the necessary funds by way of a banked or unbanked transaction, and redeem the check without the intervention of outside agencies. With this type of arrangement made available to businesses, the volume of uncollected checks can be substantially reduced. The details of the apparatus and procedure for collecting on checks returned for insufficient funds are set forth below.

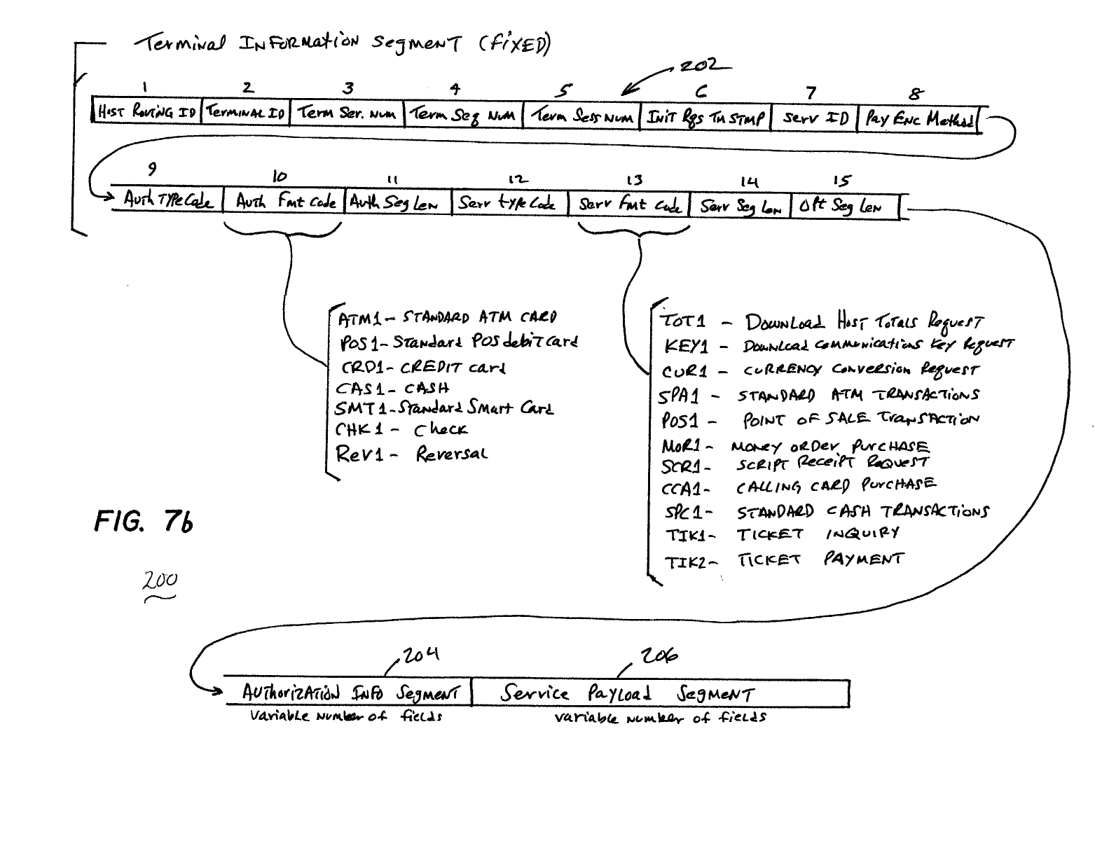

The financial system 250 shown in FIG. 8 is adapted for interfacing with retailers and other businesses for providing the capability of collecting on NSF checks in a private environment. It should be understood that the various features of the financial system 250 can be incorporated into the network 1 of FIG. 1. The multi-functional financial center, or kiosk terminal 5, is coupled to an online interactive system of the retailer 252. As noted above, the kiosk terminal 5 is configured to accept payment mediums such as ATM cards, smart cards, debit cards, cash and other payment mediums. The retailer 252 can be coupled to an NFS check collection processing center 254 associated with the transaction server 72. The NFS check collection processing center 254 is connected to the transaction server 72, which is connected to the retailer's bank 256. The retailer's bank 256, or other financial institution, is involved with regard to two issues. First, in the event that cash is the medium of payment chosen by the payor using the kiosk terminal 5, the service organization collecting the cash will deposit the appropriate cash in the retailer's bank account. This amount will generally be the amount of the uncollected check funds were, plus the service fee charged by the retailer for processing the NSF check. There is an additional financial transaction fee that must be paid by the payor for using the system 250. The latter fee charged by the owner of the kiosk terminal 5 will be debited from the retailer's bank account 256 and transferred to the transaction server 72. The transaction server 72, in turn, will transfer the funds for carrying out the transaction to the settlement bank 258.

In the event that the payment method is chosen by the payor to be by means that requires other financial networks, such is provided by the transaction server 72 to the financial networks 260. In this situation, the transaction server 72 will access the financial networks to verify that the funds are indeed available, cause the funds to be debited from the payor's account, and then cause the funds to be credited to the retailer's bank account 256.

Lastly, the processing system 254 for processing uncollected checks is coupled to a database 262 of the retailer. This database 262 is termed a “negative database” in that it stores data that is necessary for the collection of the funds in the private environment. This arrangement allows the payor of an NSF check to go to a “self serve” kiosk terminal 5 and make amends for the check that was returned to the retailer for insufficient funds.

In order for the system 250 to operate efficiently, the appropriate negative data must be stored by the retailer in the database 262. Preferably, the negative file database 262 will store all of the payor's personal identification information secured by the retailer during the business transaction in which payment was made to the retailer in the form of a personal check. The personal identification information should preferably include:

a) personal customer information—

name, address, city, state, zip code and telephone number;

b) positive identification information—

driver's license number, date of birth or passport (optional);

c) customer financial institution—

bank routing number and transit numbers and bank account number;

d) return check information—

check number, date of check, amount of check and check number;

e) status notification—

whether the transaction is cleared and paid,

whether the transaction is pending (check is in the collection time period),

whether the transaction is in transit to enforcement agency, and

whether the transaction is in the possession of the enforcement agency.

While there are many means available to the retailer for notifying the payor, a notification can be in the form of a letter advising the payor of the check that has been returned due to insufficient funds. The notification can further specify the procedure for rectifying the deficiency by using the kiosk terminal 5. The payor is preferably notified of the details of the transaction, including the amount of the check, the fee charged by the retailer for processing the insufficient funds transaction, and the fee charged by financial system 250 for providing the kiosk 5 and the supporting systems to thereby allow private involvement in the payment of the insufficient funds. Additionally, the payor is provided with a unique and private identification number for referencing the particular deficiency. The unique identification number provides an association between the payor and the particular records stored in the negative file database 262.

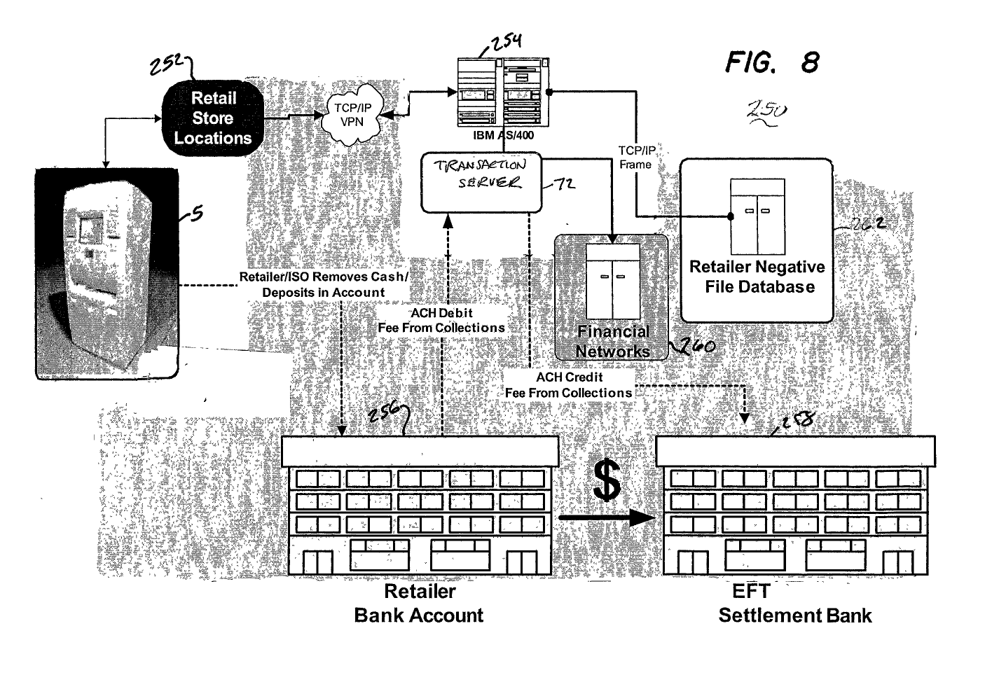

FIG. 9 is a flowchart of the general operations carried out when a payor uses a kiosk terminal 5 to reimburse a payee for a NSF check. As shown in block 270, the customer or payor enters into the kiosk terminal 5 or otherwise selects a check payment system. This is accomplished by reviewing the various prompts displayed on the touch screen 20, and selecting the account reconciliation option that allows the payor to redeem an NSF check. According to block 274, the payor enters the transaction number assigned to the transaction by the payee. According to block 276, the payor is then prompted to enter personal information, such as a driver's license number, a specific check number and the bank account number. The processor in the kiosk terminal 5 then uses this information to access the negative file database 262 of the retailer to retrieve the account information relevant to the transaction ID.

Indeed, information concerning all unpaid checks by the payor is retrieved and presented on a display to the payor. This is shown in block 278. There is also displayed, based on information retrieved from the negative file database 262, the total amount that must be submitted in order to fully redeem the NSF check. As noted above, the total amount may be the check amount, the redemption fee charged by the payee, and the transaction fee to be paid to the provider of the financial system 250. After the payor selects the check to redeem on the touch screen 20, there is presented to the payor various methods of redemption from which to choose. According to block 280, the payor inputs the method of payment, i.e., cash, debit card, debit card, smart card, bank account, etc. If no method payment is selected, or the payor chooses to abort the transaction, processing proceeds to block 282 where processing branches back to block 272 where the kiosk terminal 5 awaits an input from the payor, or another customer.

In the event that the processor in the kiosk terminal 5 detects that the payor has identified cash as the method of payment, processing branches to block 284. Here, the payor is instructed via the touch screen 20 as to the total amount of currency to insert into the bill reader 16. The payor can insert any amount of cash or currency that exceeds the total amount. Once the total amount of currency has been inserted into the bill reader 16, and the bill reader 16 verifies the authenticity of the currency, processing branches to block 290. In block 290, the method of payment is accepted, whereupon the redemption process is processed, as shown in block 292. In block 294 the system 250 calculates any change that may be due to the payor if an overpayment is made. In other words, if the total amount to be paid by the payor to redeem a check is $38.95, and two twenty dollar bills are inserted into the bill changer 16, then change in the amount of 1.05 is due the payor. In program flow block 296, the processor in the kiosk terminal 5 prints a receipt for the payor, with the transaction number and other relevant information. The date, time, and method of payment are also printed on the receipt. The receipt is printed by the printer 21, as shown by block 298. Change is made to the payor by way of a negotiable instrument, such as a money order, as noted in block 300.

With reference back to program flow block 280, if the method of payment input into the kiosk terminal 5 by the payor was other than currency, processing branches to block 286. In block 286, if the method of payment chosen by the payor was a bank card, debit card or a savings account, then the appropriate visual prompts are presented on the touch screen 20 to the payor. After input of the appropriate information, or the swiping of the relevant card, such information is collected, processed and forwarded electronically to a bank card authorization switch 40. This is shown in program flow block 288. The processing proceeds as described above.

In the event that the transaction is aborted, such as because the chosen method of payment cannot be accomplished, then processing branches back to block 272, via block 282.

When carrying out check redemption functions, the transaction server 72 is configured to report all transactions that have been initiated at each kiosk terminal 5. The reports are generated as a raw data file in the ASCII text, formatted according to the specifications of each merchant or retailer. The retailer financial system is preferably configured to import the report file in a database to balance the total amount of funds collected between predefined closing periods. In addition to the foregoing, an ACH report is created by the transaction server 72. The ACH report constitutes the total detailed records that balance with the raw data file, indicating the total amount of funds that will be credited to the retailer's bank account. The ACH report will be a reflection of the cumulative total amount collected per kiosk terminal 5, the total for the day, less the transaction fee paid to the provider of the financial system 250 for providing the on-line processing transactions.

The financial settlement procedures involved with the financial system 250 include the provision of the reconciliation and the balancing of the check redemption transactions on a periodic basis, such as every day. The kiosk terminal 5 can be closed for reconciliation under the following conditions, namely, when manually closed by a service person at any time while removing cash from the currency cassette to perform the daily close. The kiosk terminal 5 can also be closed automatically at a predefined time to carry out reconciliation and balancing functions.

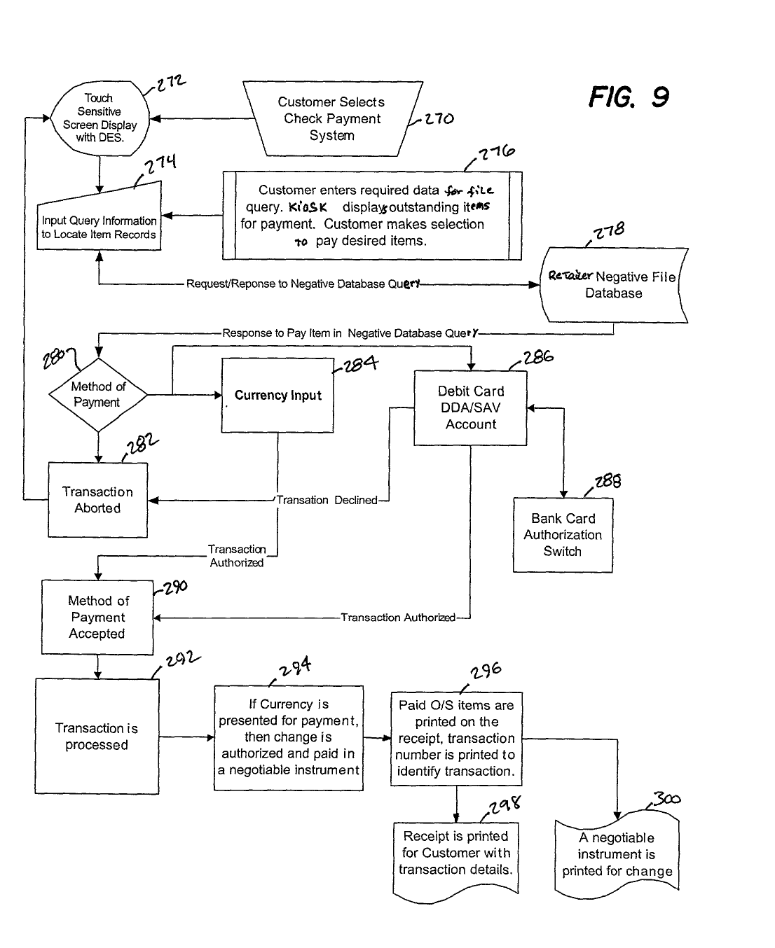

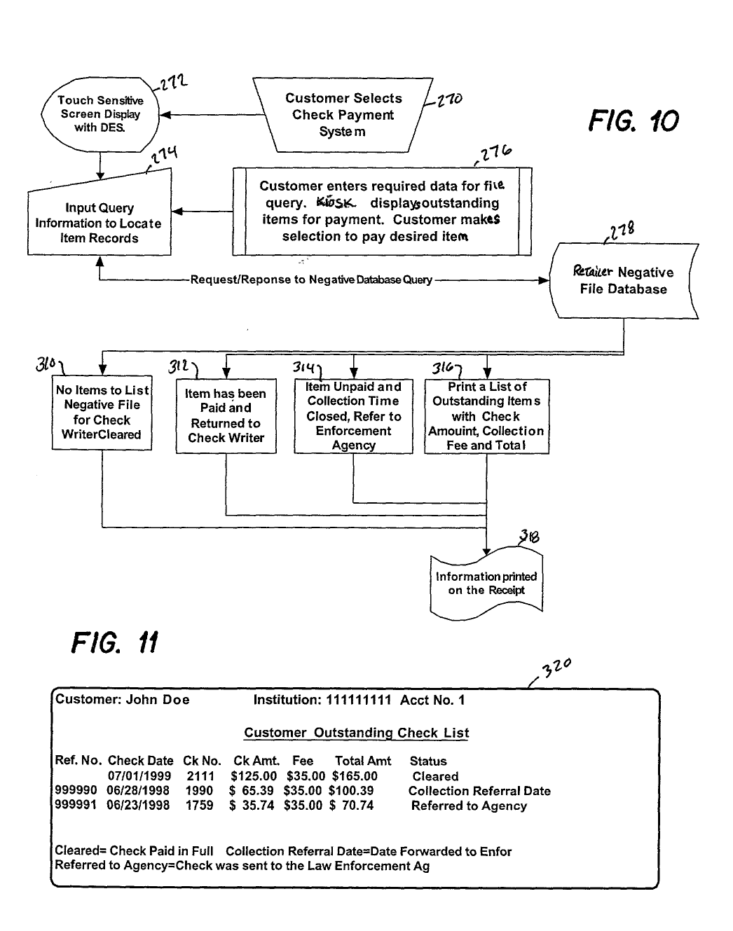

With reference now to FIG. 10 there is shown a flowchart of the process flow in connection with an inquiry by a payor. A payor of a check can utilize the kiosk terminal 5 to inquire as to the status of various checks issued to the retailer as the payee. Blocks 270-278 are substantially identical to those blocks of like reference numerals noted in FIG. 9, and thus function in the same manner as described above. The information returned by the retailer from the negative file database 262 can be similar to that shown in function blocks 310-316. In block 310, the status information returned from the negative file database 262 is of the type that indicates that no items are listed in the retailer's negative file data base 262 for that payor for which the check(s) has not cleared. In block 312, the message returned from the retailer's negative file database 262 indicates that the item has been paid for by alternative means, and the NSF check has been returned to the payor. The function of block 314 provides a message indicating that the item purchased has not yet been paid for, the collection time is closed, and the matter has been referred to a n enforcement agency. In block 316, the payor can request that a list of outstanding items be printed, together with the status of each item. FIG. 11 illustrates a sample printout of the result of the function of block 316. It is noted that with respect to check 2111, the total amount does not represent the sum of the check amount and the “fee”. The reason for this is that the payor used the financial system 250 to redeem such check and thus there was an additional financial system transaction fee.

The status report 320 can be displayed on the touch screen 230 of the kiosk terminal 5, or printed on a tangible medium, such as indicated in block 318.

Although the preferred embodiment has been described in detail, it should be understood that various changes, substitutions and alterations can be made therein without departing from the spirit and scope of the invention as defined by the appended claims.

What is claimed is:

1. A message format for use in communicating information, comprising:
a plurality of message segments, each message segment having one or more data fields;
a first message segment having at least one data field storing data that does not change for each communication of financial information;
a second message segment having an arrangement of data fields that store data as a function of the type of financial transaction, and said arrangement of data fields changes for different financial transactions; and
said first message segment having a field that defines a format of the data fields of said second message segment, whereby the format of said second message segment is variable and changes as a function of the type of financial transaction communicated.

2. The message format of claim 1, further including a third message segment having a plurality of fields, an arrangement of the fields of said third segment being a function of the type of goods/service to purchase, and further including at least one field in said first message segment defining a format of the arrangement of data fields in said third segment.

3. The message format of claim 1, wherein said first message segment has a data field that defines a terminal from which a user of the terminal initiates a financial transaction, and said second message defines a method of payment chosen by the user of the terminal.

4. The message format of claim 2, wherein said third message segment includes at least one data field relating to a product or service being purchased by the user via the terminal.

5. The message format of claim 3, wherein one data field of said second message segment is adapted for holding data indicating that a chosen method of payment by the user is currency.

6. The message format of claim 1, wherein said second message segment includes different numbers of data fields as a function of the methods of payments allowed by the terminal, and the data in the respective fields is different.

7. A message format for use in communicating financial information, comprising:
a first message segment, a second message segment and a third message segment;
said first message segment having one or more data fields storing data for identifying a terminal from which a financial transaction is communicated using said message format, said first message segment having at least one data field defining an arrangement of data fields of said second message segment, and said first message segment having at least one data field defining an arrangement of data fields of said third message segment;
said second message segment for carrying data in respective fields thereof relating to a method of payment selected by a user using the terminal; and
said third message segment for carrying data in respective fields thereof relating to an identification of goods or services selected by the user of the terminal.

8. The message segment of claim 7, wherein a data field of said first message segment specifies one of a method of payment selected from a group consisting of ATM card, credit card, debit card, smart card or cash.
